(19) United States
(12) Patent Application Publication
(10) Pub. No.: US 2026/0095747 A1
(43) Pub. Date: Apr. 2, 2026

(54) ELECTRONIC DEVICE FOR LIMITING REPEATED REGISTRATION ATTEMPTS OF ROAMING SUBSCRIBER IDENTIFICATION MODULE AND OPERATING METHOD THEREOF

(71) Applicant: Samsung Electronics Co., Ltd., Suwon-si (KR)

(72) Inventors: Van Hau TRUONG, Hanoi (VN); Van Thinh NGUYEN, Hanoi (VN); The Thoi NGUYEN, Hanoi (VN); Duc Doan NGUYEN, Hanoi (VN); Van Hung NGUYEN, Hanoi (VN)

(21) Appl. No.: 19/318,603

(22) Filed: Sep. 4, 2025

(30) Foreign Application Priority Data
Sep. 27, 2024 (KR) 10-2024-0131702

(51) Int. Cl. H04W 8/18; H04W 60/00; H04W 60/04; H04W 64/00

(52) U.S. Cl. CPC H04W 8/183; H04W 60/001; H04W 60/04; H04W 64/00

(57) ABSTRACT

An electronic device for limiting repeated registration attempts of a roaming subscriber identification module (SIM) and/or an operating method thereof are provided. The electronic device may include memory storing instructions and at least one processor for executing the instructions, and when the at least one processor individually and/or collectively executes the instructions, the instructions cause the electronic device to detect a change of a country that provides a mobile network based on a broadcast message received via the mobile network, change a roaming SIM and a local SIM based on the change of country, connect to the mobile network via the local SIM, and prevent and/or reduce degradation of communication performance between the local SIM and the mobile network by restricting repeated resource requests of the roaming SIM for a radio frequency (RF) resource to register the roaming SIM with the mobile network.

### CROSS-REFERENCE TO RELATED APPLICATIONS

This application claims the benefit under 35 USC §119(a) of Korean Patent Application No. 10-2024-0131702, filed on Sep. 27, 2024, in the Korean Intellectual Property Office, the disclosures of which are all hereby incorporated by reference herein in their entireties.

### BACKGROUND

### 1. Field

In certain example embodiments, there may be provided an electronic device for limiting repeated registration attempts of a roaming subscriber identification module (SIM) and/or an operating method thereof are provided.

### 2. Description of Related Art

Dual subscriber identification module (SIM) dual standby (DSDS) is technology that uses two SIM cards in an electronic device, such as a smartphone. Two SIM cards including two SIM card slots may be mounted in an electronic device that supports DSDS. The two SIM cards mounted in the electronic device may be issued by carriers in different countries. When a country where the electronic device is currently located is the same as a country where a SIM card is issued, the electronic device may determine the SIM card to be a local SIM and the other SIM card to be a roaming SIM.

The above information may be presented as the related art to help with the understanding of the disclosure. No arguments or decisions are raised as to whether any of the above description is applicable as the prior art related to the present disclosure.

### SUMMARY

According to an example embodiment, the electronic device may include memory storing instructions. The electronic device may include at least one processor, comprising processing circuitry, for executing the instructions. When the at least one processor, individually and/or collectively, executes the instructions, the instructions may cause the electronic device to detect a change of a country that provides a mobile network based on a broadcast message received via the mobile network. When the at least one processor individually and/or collectively executes the instructions, the instructions may cause the electronic device to change a roaming subscriber identification module (SIM) and a local SIM based on the change of country. When the at least one processor individually and/or collectively executes the instructions, the instructions may cause the electronic device to connect to the mobile network via the local SIM. When the at least one processor individually and/or collectively executes the instructions, the instructions may cause the electronic device to prevent and/or reduce degradation of communication performance between the local SIM and the mobile network by restricting repeated resource requests of the roaming SIM for a radio frequency (RF) resource to register the roaming SIM with the mobile network.

According to an example embodiment, an electronic device may include memory storing instructions. The electronic device may include at least one processor, comprising processing circuitry, for executing the instructions. When the at least one processor individually and/or collectively executes the instructions, the instructions cause the electronic device to attempt to register a roaming SIM, in response to changing a local SIM connected to a mobile network. When the at least one processor individually and/or collectively executes the instructions, the instructions cause the electronic device to identify whether the roaming SIM is successfully registered. When the at least one processor individually and/or collectively executes the instructions, the instructions cause the electronic device to determine whether a count of consecutive registration rejections of the roaming SIM exceeds a threshold value, when the registration of the roaming SIM is rejected. When the at least one processor individually and/or collectively executes the instructions, the instructions cause the electronic device to control an RF priority indicating a priority of using an RF resource of the roaming SIM and/or a waiting time for retrying the registration of the roaming SIM, when the count of consecutive registration rejections of the roaming SIM exceeds the threshold value.

According to an example embodiment, a method of operating an electronic device may include detecting a change of country that provides a mobile network based on a broadcast message received via the mobile network. The method may include determining a roaming SIM and a local SIM based on the change of country. The method may include connecting to the mobile network via the local SIM. The method may include preventing and/or reducing degradation of communication performance between the local SIM and the mobile network by restricting repeated resource requests of the roaming SIM for an RF resource to register the roaming SIM with the mobile network.

According to an example embodiment, a method of operating an electronic device may include attempting to register a roaming SIM, in response to changing a local SIM connected to a mobile network. The method may include identifying whether the roaming SIM is successfully registered. The method may include, when the registration of the roaming SIM is rejected, determining whether a count of consecutive registration rejections of the roaming SIM exceeds a threshold value. The method may include, when the count of consecutive registration rejections of the roaming SIM exceeds the threshold value, controlling an RF priority indicating a priority of using an RF resource of the roaming SIM and/or a waiting time for retrying the registration of the roaming SIM.

According to an example embodiment, a non-transitory computer-readable storage medium may store one or more computer programs including instructions. The instructions, when executed individually and/or collectively by at least one processor, cause an electronic device to detect a change of a country that provides a mobile network based on a broadcast message received via the mobile network. The instructions, when executed individually and/or collectively by at least one processor, cause the electronic device to determine a roaming SIM and a local SIM based on the change of the country. The instructions, when executed individually and/or collectively by at least one processor, cause the electronic device to connect to the mobile network via the local SIM. The instructions, when executed individually and/or collectively by at least one processor, cause the electronic device to prevent and/or reduce degradation of communication performance between the local SIM and the mobile network by restricting repeated resource requests of the roaming SIM for an RF resource to register the roaming SIM with the mobile network.

According to an example embodiment, a non-transitory computer-readable storage medium stores one or more computer programs including instructions. The instructions, when executed individually and/or collectively by at least one processor, cause an electronic device to attempt to register a roaming SIM, in response to changing a local SIM connected to a mobile network. The instructions, when executed individually and/or collectively by at least one processor, cause the electronic device to identify whether the roaming SIM is successfully registered. The instructions, when executed individually and/or collectively by at least one processor, cause the electronic device to, when the registration of the roaming SIM is rejected, determine whether a count of consecutive registration rejections of the roaming SIM exceeds a threshold value. The instructions, when executed individually and/or collectively by at least one processor, cause the electronic device to, when the count of consecutive registration rejections of the roaming SIM exceeds the threshold value, control an RF priority indicating a priority of using an RF resource of the roaming SIM and/or a waiting time for retrying the registration of the roaming SIM.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram of an electronic device in a network environment according to an example embodiment;

FIG. 2 is a block diagram of an electronic device in a network environment including a plurality of cellular networks according to an example embodiment;

FIG. 3 is a diagram illustrating a problem resulting from a conventional local subscriber identification module (SIM) change;

FIGS. 4 and 5 are diagrams illustrating a problem that occurs when repeatedly attempting to register a conventional local SIM with a mobile network;

FIG. 6 is a diagram illustrating an operation of an electronic device according to an example embodiment;

FIG. 7 is a diagram illustrating a method of determining whether a country that provides a mobile network is changed according to an example embodiment;

FIG. 8 is a diagram illustrating a user interface (UI) that notifies that a local SIM is changed according to an example embodiment;

FIG. 9 is a diagram illustrating an operation between an electronic device and a base station according to an example embodiment;

FIG. 10 is a diagram illustrating an increment of a waiting time based on a rejection cause and a decrement of a radio frequency (RF) priority according to an example embodiment;

FIG. 11 is a diagram illustrating initialization of an RF priority and a waiting time according to an example embodiment;

FIG. 12 is a diagram illustrating an operation between an electronic device and a base station according to an example embodiment;

FIG. 13 is a diagram illustrating an operation of an electronic device when both SIMs are roaming SIMs according to an example embodiment; and

FIG. 14 is a flowchart illustrating an operating method of an electronic device according to an example embodiment.

### DETAILED DESCRIPTION

Hereinafter, certain example embodiments will be described in detail with reference to the accompanying drawings. When describing the embodiments with reference to the accompanying drawings, like reference numerals refer to like elements and a repeated description related thereto will be omitted.

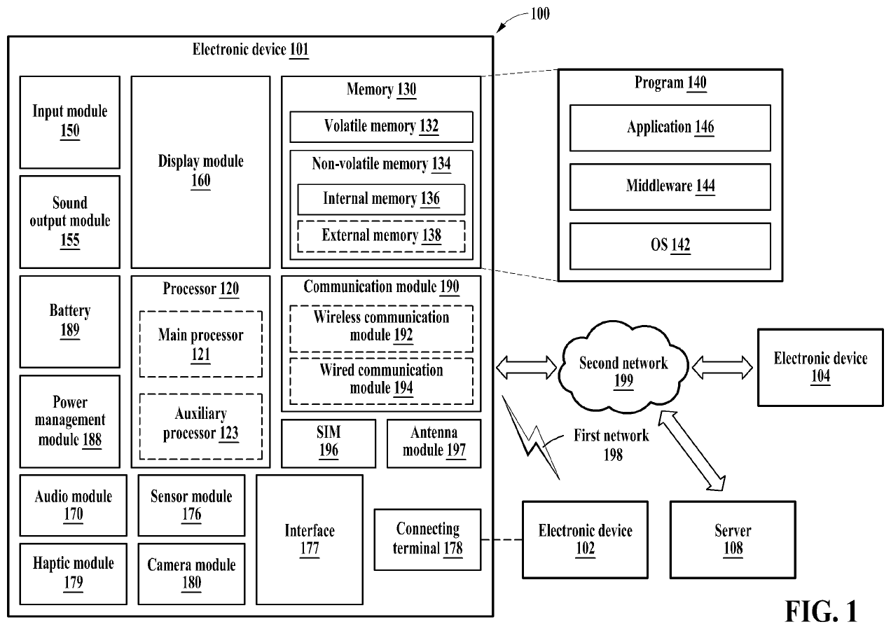

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120, comprising processing circuitry, may execute, for example, software (e.g., a program 140) to control at least one other component (e.g., a hardware or software component) of the electronic device 101 connected, directly or indirectly, to the processor 120 and may perform various data processing or computation. According to an embodiment, as at least part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specialized for a designated function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated by machine learning. Such learning may be performed, for example, by the electronic device 101 in which an artificial intelligence model is executed, or via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive, from the outside (e.g., a user) of the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure an intensity of a force incurred by the touch. The display module 160 may be implemented with, for example, a foldable structure and/or a rollable structure. For example, a size of a display screen of the display module 160 may be reduced when folded and expanded when unfolded.

The audio module 170 may convert a sound into an electrical signal or vice versa. According to an embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected, directly or indirectly, to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus, which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the components described above may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled, directly or indirectly, with the second network 199. Each of the external electronic devices 102 and 104 may be a device of the same type as or a different type from the electronic device 101. According to an embodiment, all or some of operations to be executed by the electronic device 101 may be executed by one or more of the external electronic devices 102, 104, or 108. For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the external electronic device 104 or the server 108 may be included in the second network 199.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the item, unless the relevant context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. Terms such as “first,” “second,” “first,” or “second” may be used simply to distinguish one component from another and may not limit the components with respect to other aspects (e.g., importance or order). It is to be understood that if a component (e.g., a first component) is referred to, with or without the term “operatively” or “communicatively”, as “coupled with,” “coupled to,” “connected with,” or “connected to” another component (e.g., a second component), it means that the component may be coupled with the other component directly (e.g., by wire), wirelessly, or via at least a third component(s). Thus, for example, “connected” as used herein covers both direct and indirect connections.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

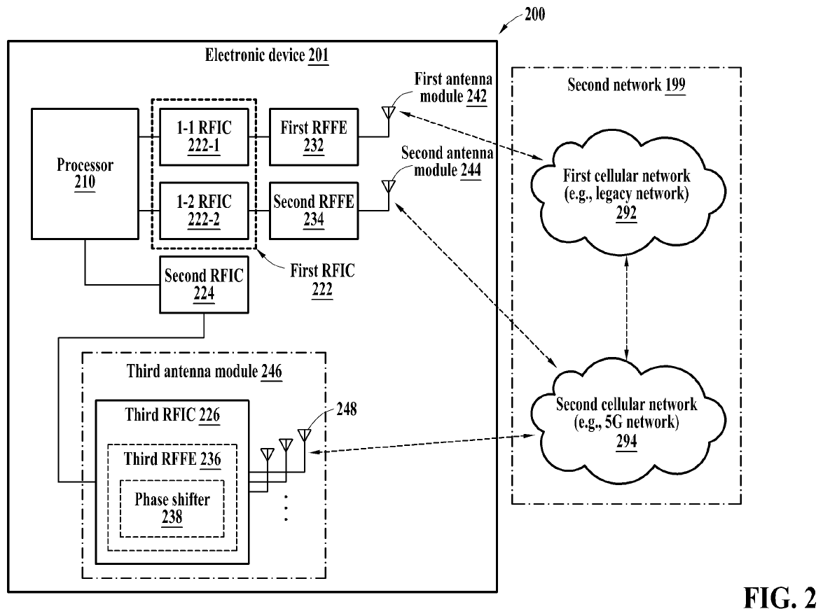

FIG. 2 is a block diagram of an electronic device 201 in a network environment 200 including a plurality of cellular networks according to an embodiment.

Referring to FIG. 2, an electronic device 201 (e.g., the electronic device 101 of FIG. 1) may include a processor 210 (e.g., the processor 120 of FIG. 1 or a CP), a 1-1th radio frequency integrated circuit (RFIC) 222-1, and a 1-2th RFIC 222-2, a second RFIC 224, a first radio frequency front end (RFFE) 232, a second RFFE 234, a first antenna module 242, a second antenna module 244, and a third antenna module 246. Depending on embodiments, the 1-1th RFIC 222-1 and the (1-2) RFIC 222-2 may be implemented as one RFIC 222. The second network 199 may include a first cellular network 292 (e.g., a legacy network) and a second cellular network 294 (e.g., a 5G network). The electronic device 201 may further include at least one of the components described with reference to FIG. 1, and the second network 199 may further include at least one another network. According to an embodiment, the second RFIC 224 may be omitted or may be included as a portion of the third RFIC 226.

According to an embodiment, the (1-1)-th RFIC 222-1, the (1-2)-th RFIC 222-2, the second RFIC 224, the first RFFE 232, and the second RFFE 234 of FIG. 2 may be included in the communication module 190 (e.g., the wireless communication module 192) of FIG. 1, and the first antenna module 242, the second antenna module 244, and the third antenna module 246 of FIG. 2 may be included in the antenna module 197 of FIG. 1.

According to an embodiment, the processor 210 may establish a communication channel of a band to be used for wireless communication with the first cellular network 292 and support legacy network communication through the established communication channel. The first cellular network 292 may be, for example, a legacy network including a second generation (2G), 3G, 4G, or long-term evolution (LTE) network. The processor 210 may establish a communication channel corresponding to a first band (e.g., approximately 6 GHz to 60 GHz) (or a 5G standard frequency range (FR) 2 (e.g., 24.25 GHz to 52.6 GHz) of bands to be used for wireless communication with the second cellular network 294 and may support 5G network communication through the established communication channel. The second cellular network 294 may be a 5G network defined by a third generation partnership project (3GPP). The processor 210 may establish a communication channel corresponding to a second band (e.g., approximately less than or equal to 6 GHz) (or a 5G standard FR1 (e.g., 410 MHz to 7.125 GHz) of bands to be used for wireless communication with the second cellular network 294 and may support 5G network communication through the established communication channel.

According to an embodiment, during transmission, the (1-1)-th RFIC 222-1 (or the first RFIC 222) may convert a baseband signal generated by the processor 210 into a radio frequency (RF) signal of a frequency band (e.g., about 700 MHz to about 3 GHz) to be used in the first cellular network 292. During reception, an RF signal may be received or acquired from the first cellular network 292 via the first antenna module 242 and may be preprocessed through the first RFFE 232. The (1-1)-th RFIC 222-1 (or the first RFIC 222) may convert the preprocessed RF signal into a baseband signal such that the signal may be processed by the processor 210.

According to an embodiment, during transmission, the (1-2)-th RFIC 222-2 (or the first RFIC 222) may convert a baseband signal generated by the processor 210 into an RF signal (hereinafter, referred to as a “5G Sub6 RF signal”) of a Sub6 band (e.g., about 6 GHz or less) to be used in the second cellular network 294. During reception, the 5G Sub6 RF signal may be received or acquired from the second cellular network 294 via the second antenna module 244 and may be preprocessed through the second RFFE 234. The (1-2)-th RFIC 222-2 (or the first RFIC 222) may convert the preprocessed 5G Sub6 RF signal into a baseband signal such that the signal may be processed by the processor 210.

According to an embodiment, the third RFIC 226 may convert a baseband signal generated by the processor 210 into an RF signal (hereinafter, referred to as a “5G Above6 RF signal”) of a 5G Above6 band (e.g., about 6 GHz to about 60 GHz) to be used in the second cellular network 294. During reception, the 5G Above6 RF signal may be received or obtained from the second cellular network 294 through the third antenna module 246 (e.g., an antenna 248) and may be preprocessed through the third RFFE 236. The third RFIC 226 may convert the preprocessed 5G Above6 RF signal into a baseband signal to be processed by the processor 210. According to an embodiment, the third RFFE 236 may be formed as a portion of the third RFIC 226.

According to an embodiment, the electronic device 201 may include the second RFIC 224 separately from the third RFIC 226 or as at least a portion of the third RFIC 226. In this case, the second RFIC 224 may convert the baseband signal generated by the processor 210 into an RF signal (hereinafter, referred to as an IF signal) of an intermediate frequency band (e.g., approximately 9 GHz to 11 GHz) and may transmit the IF signal to the third RFIC 226. The third RFIC 226 may convert the IF signal into the 5G Above6 RF signal. During reception, the 5G Above6 RF signal may be received or obtained from the second cellular network 294 through the third antenna module 246 (e.g., the antenna 248) and may be converted into an IF signal by the third RFIC 226. The second RFIC 224 may convert the IF signal into a baseband signal such that the processor 210 may process the IF signal.

According to an embodiment, at least one of the first antenna module 242 and the second antenna module 244 may be omitted or may be combined with another antenna module to process RF signals in a plurality of corresponding bands.

According to an embodiment, the third RFIC 226 and the antenna 248 may be disposed on the same substrate and may form the third antenna module 246. For example, the processor 120 may be disposed on a first substrate (e.g., a main PCB). In this case, as the third RFIC 226 is disposed on a partial area (e.g., a bottom surface) of a second substrate (e.g., a sub PCB) separate from the first substrate and the antenna 248 is disposed on the other partial area (e.g., a top surface) of the second substrate (e.g., the sub PCB), the third antenna module 246 may be formed. The length of a transmission line between the third RFIC 226 and the antenna 248 may be reduced by disposing the third RFIC 226 and the antenna 248 on the same substrate. This may reduce, for example, the loss (e.g., attenuation) of a signal in a high frequency band (e.g., approximately 6 GHz to 60 GHz) used for 5G network communication due to a transmission line. Thus, the electronic device 201 may enhance the quality or speed of communication with the second cellular network 294 (e.g., a 5G network).

According to an embodiment, the antenna 248 may be formed as an antenna array including a plurality of antenna elements that may be used for beamforming. In this case, the third RFIC 226 may include, for example, a plurality of phase shifters 238 corresponding to the plurality of antenna elements as a portion of the third RFFE 236. During transmission, each of the plurality of phase shifters 238 may convert a phase of a 5G Above6 RF signal to be transmitted to the outside (e.g., a base station of a 5G network) of the electronic device 201 through a corresponding antenna element. During reception, each of the plurality of phase shifters 238 may convert a phase of a 5G Above6 RF signal received from the outside (e.g., the base station of the 5G network) through the corresponding antenna element into the same or substantially the same phase. This may enable a transmission or reception through beamforming between the electronic device 201 and the outside.

The second cellular network 294 may be operated independently of the first cellular network 292 (e.g., standalone (SA)) or in connection to the first cellular network 292 (e.g., non-standalone (NSA)). For example, a 5G network may include only an access network (e.g., a 5G radio access network (RAN) or a next generation RAN (NG RAN)) and may not include a core network (e.g., a next generation core (NGC)). In this case, after accessing an access network of the 5G network, the electronic device 201 may access an external network (e.g., the Internet) under a control of a core network (e.g., an evolved packet core (EPC)) of a legacy network. Protocol information (e.g., LTE protocol information) for communication with the legacy network or protocol information (e.g., new radio (NR) protocol information) for communication with the 5G network may be stored in a memory (e.g., the memory 130 of FIG. 1) and may be accessed by the processor 210.

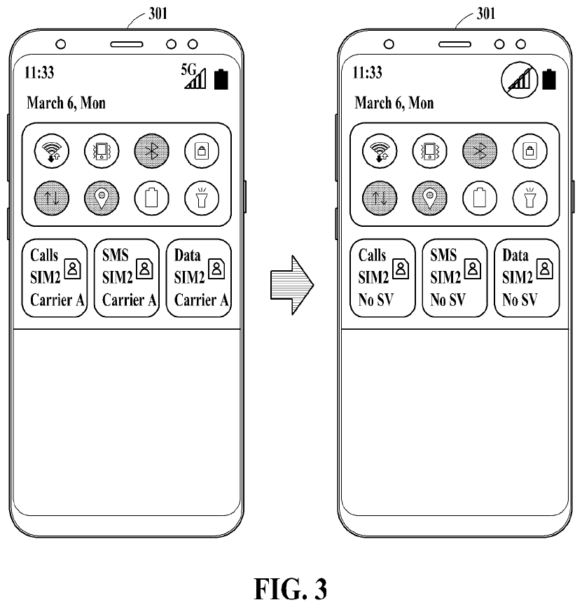

FIG. 3 is a diagram illustrating a problem resulting from a conventional local subscriber identification module (SIM) change.

Referring to FIG. 3, an electronic device 301 (e.g., the electronic device 101 of FIG. 1 and the electronic device 201 of FIG. 2) is illustrated. The electronic device 301 may support dual SIM dual standby (DSDS). The electronic device 301 may include two SIMs (e.g., SIM 1 and SIM 2). For example, the electronic device 301 may include SIM 1 that supports the connection with a mobile network (e.g., the second network 199 of FIG. 2, the first cellular network 292 of FIG. 2, and the second cellular network 294 of FIG. 2) provided by carrier B in country Y and SIM 2 that supports the connection with a mobile network provided by carrier A of country X.

According to an embodiment, when the electronic device 301 is located in country X, SIM 1 may be determined to be a roaming SIM and SIM 2 may be determined to be a local SIM. When the electronic device 301 is located in country Y, SIM 1 may be determined to be a local SIM and SIM 2 may be determined to be a roaming SIM. For example, when the electronic device 301 is located in country X and SIM 2 is set as a default SIM card, the electronic device 301 may be connected to a mobile network via SIM 2, which is the local SIM. For example, the electronic device 301 may be provided with the mobile network from carrier A.

According to an embodiment, the electronic device 301 may move from country X to country Y. For example, the electronic device 301 may be an electronic device of a user who frequently travels from country X to country Y. When the location of the electronic device 301 moves from country X to country Y, the local SIM may be changed from SIM 2 to SIM 1. When the location of the electronic device 301 moves from country X to country Y, the local sim may be changed from SIM 1 to SIM 2.

According to an embodiment, SIM 2 may not provide a roaming service. For example, when the user does not subscribe to the roaming service, SIM 2 may not provide the roaming service. Although the electronic device 301 moves from country X to country Y, since SIM 2 is still set as the default SIM card and SIM 2 does not provide the roaming service, the electronic device 301 may not provide a calling service, a short message service (SMS), and a data service to the user.

According to an embodiment, SIM 1, which is the local SIM, may be successfully registered with the mobile network provided by carrier B in country Y. Even though SIM 1 is registered with the mobile network provided by carrier B, since the default SIM card is still set to SIM 2, the electronic device 301 may not provide the calling, SMS, and data services to the user via SIM 1.

Accordingly, when the country is changed, a method of receiving the calling, SMS, and data services via a local SIM corresponding to the changed country may be required.

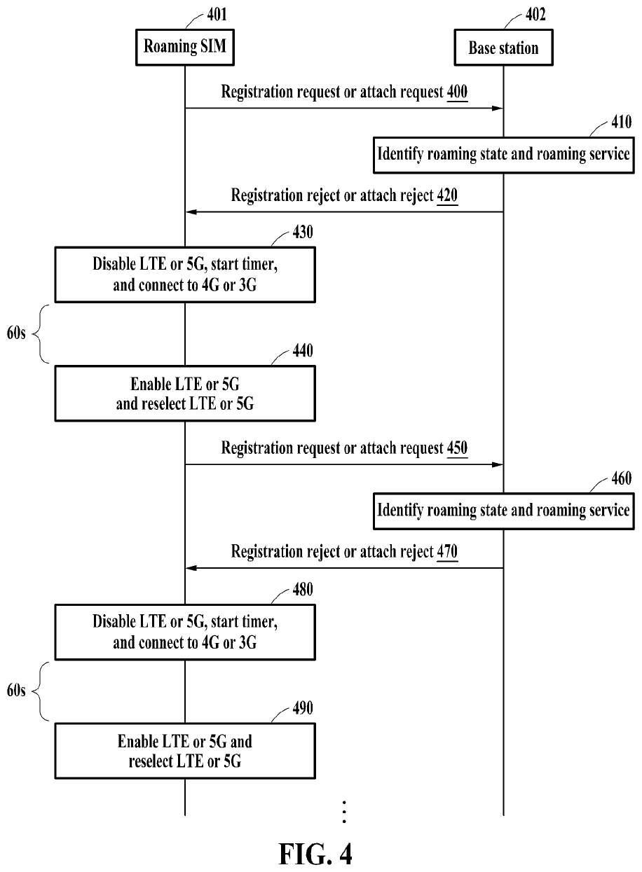

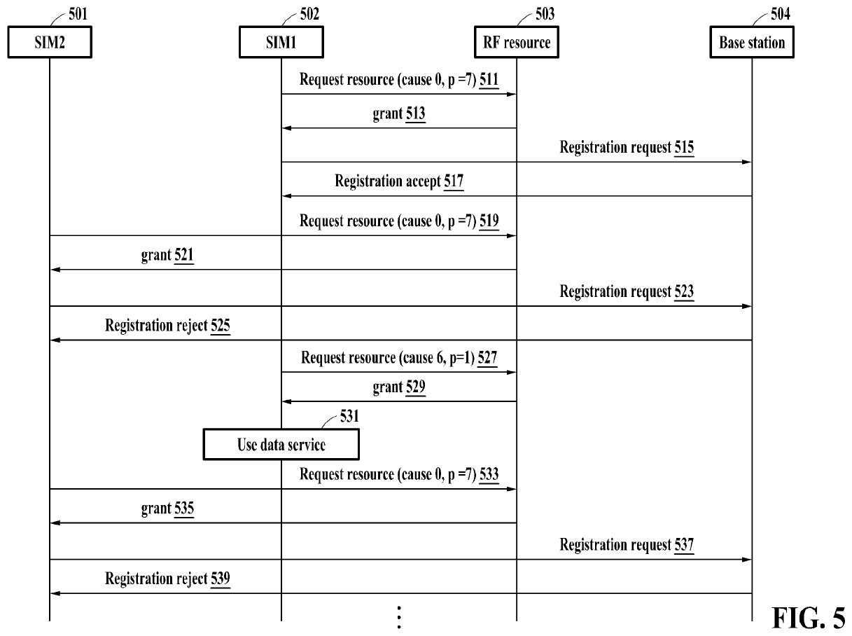

FIGS. 4 and 5 are diagrams illustrating a problem that occurs when repeatedly attempting to register a conventional local SIM with a mobile network.

Referring to FIG. 4, a flowchart for illustrating operations between an electronic device 401 (e.g., the electronic device 101 of FIG. 1, the electronic device 201 of FIG. 2, and the electronic device 301 of FIG. 3) and a base station 402 is illustrated.

According to an embodiment, the electronic device 401 may include a roaming SIM. The roaming SIM may support a connection with a mobile network service (e.g., the second network 199 of FIG. 1, the first cellular network 292 of FIG. 2, and the second cellular network 294 of FIG. 2) provided by a specific carrier in a foreign country other than a country where the electronic device 401 is currently located. Herein, it is assumed that the electronic device 401 is not subscribed to a roaming service using a roaming SIM.

According to an embodiment, the base station 402 may be a base station in the country where the electronic device 401 is currently located. The base station 402 may perform communication with the electronic device 401. The base station 402 may provide registration of a roaming SIM through the communication with the electronic device 401.

In the following embodiments, operations may be performed sequentially but not necessarily. For example, the order of the operations may change, and at least two of the operations may be performed in parallel. At least some of operations 400 to 490 may be performed by at least one component of the electronic device 401. For example, instructions stored in memory (e.g., the memory 130 of FIG. 1) may be collectively and/or individually executed by at least one processor (e.g., the processor 120 of FIG. 1 and the processor 210 of FIG. 2), and the instructions may cause the electronic device to perform at least some of operations 400 to 490 below.

In operation 400, the electronic device 401 may transmit, to the base station 402, a message to request registration of a roaming SIM with a wireless network. For example, when requesting registration with a 5G network, the electronic device 401 may transmit a registration request message to the base station 402. For example, when requesting registration with a 4G network, the electronic device 401 may transmit an attach request message to the base station 402.

In operation 410, the base station 402 that receives the message may identify a roaming state and a roaming service for the roaming SIM. The base station 402 may identify the roaming state and the roaming service for the roaming SIM. The base station 402 may determine whether the SIM that transmits the message corresponds to the roaming state (e.g., whether the SIM is a roaming SIM) and whether the electronic device 401 is subscribed to the roaming service with respect to the roaming SIM. For example, the base station 402 may determine that the SIM that the electronic device 401 requests to register corresponds to the roaming SIM, but the roaming SIM is not subscribed to the roaming service.

In operation 420, the base station 402 may transmit a registration reject message to the electronic device 401. For example, when the electronic device 401 requests registration with the 5G network, the base station 402 may transmit the registration reject message to the electronic device 401. For example, when the electronic device 401 requests registration with the 4G network, the base station 402 may transmit an attach reject message to the electronic device 401. For example, the base station 402 may transmit a message to the electronic device 401 indicating that the registration of the roaming SIM has failed due to reject cause #29 of the 3GPP specification.

In operation 430, the electronic device 401 may disable 4G or 5G. The electronic device 401 may start a timer for a re-registration attempt. The electronic device 401 may be connected to 4G or 3G. For example, when the electronic device 401 attempts to register the roaming SIM with the 5G network, the electronic device 401 that receives the registration reject message may disable a 5G function of the roaming SIM, may start a timer (e.g., T3502) for a re-registration attempt, and may connect the roaming SIM to the 4G network. For example, when the electronic device 401 attempts to register the roaming SIM with the 4G network, the electronic device 401 that receives the registration reject message may disable a 4G function of the roaming SIM, may start a timer (e.g., T3402) for a re-registration attempt, and may connect the roaming SIM to the 3G network.

In operation 440, the electronic device 401 may re-attempt the registration by activating the 4G or 5G function for the roaming SIM and reselecting 4G or 5G. The electronic device 401 may attempt to register the roaming SIM with the 4G network or the 5G network after a waiting time (e.g., 60 seconds) has elapsed according to the start of the timer. For example, when the registration of the roaming SIM with the 5G network is rejected, after the waiting time has elapsed, the electronic device 401 may enable the 5G function of the roaming SIM and may re-attempt the registration with the 5G network. For example, when the registration of the roaming SIM with the 4G network is rejected, after the waiting time has elapsed, the electronic device 401 may enable the 4G function of the roaming SIM and may re-attempt the registration with the 4G network.

Since operations 450 to 490 correspond to operations 400 to 440, respectively, a detailed description thereof is omitted.

According to an embodiment, the electronic device 401 may iteratively perform operations 400 to 440 until the roaming SIM is successfully registered with the mobile network. The registration with the mobile network may use an RF resource of the electronic device 401 preferentially over other operations. Due to repeated registration attempts to register the roaming SIM with the mobile network, other operations (e.g., using a mobile network service via a local SIM) using the RF resource may be interrupted.

Hereinafter, performance degradation of the mobile network due to repeated registration attempts to register the roaming SIM with the mobile network is described.

FIG. 5 illustrates SIM 2 501, SIM 1 502, a CP 503, and a base station 504 (e.g., the base station 402 of FIG. 4). SIM 2 501, SIM 1 502, and the CP 503 may be included in an electronic device (e.g., the electronic device 101 of FIG. 1, the electronic device 201 of FIG. 2, the electronic device 301 of FIG. 3, and the electronic device 401 of FIG. 4). The electronic device may include a device that supports DSDS. Hereinafter, it is assumed that SIM 2 501 is a roaming SIM and SIM 1 502 is a local SIM. Hereinafter, it is assumed that SIM 2 501 does not provide a roaming service because, for example, SIM 2 is not subscribed to the roaming service. In the following embodiments, operations may be performed sequentially but not necessarily. For example, the order of the operations may change, and at least two of the operations may be performed in parallel. At least some of operations 511 to 539 may be performed by at least one component of the electronic device. For example, instructions stored in memory (e.g., the memory 130 of FIG. 1) may be collectively and/or individually executed by at least one processor (e.g., the processor 120 of FIG. 1 and the processor 210 of FIG. 2), and the instructions may cause the electronic device to perform at least some of operations 511 to 539 below.

In operation 511, SIM 1 502 (e.g., the local SIM) may send, to the CP 503, a request to allocate resources. For example, SIM 1 502 may send, to the CP 503, a request to allocate resources because of cause 0 that has an RF priority of 7. For example, cause 0 may include a resource request to register SIM 1 502 with a mobile network (e.g., the second network 199 of FIG. 1, the first cellular network 292 of FIG. 2, and the second cellular network 294 of FIG. 2).

In operation 513, the CP 503 may allocate (grant) the RF resource to SIM 1 502 in response to the resource allocation request of SIM 1 502. An RF resource 503 may include an antenna module (e.g., the antenna module 197 of FIG. 1, the first antenna module 242 of FIG. 2, the second antenna module 244 of FIG. 2, and the third antenna module 246 of FIG. 3) included in the electronic device.

In operation 515, SIM 1 502 may transmit a message to request registration of SIM 1 502 with a wireless network to the base station 504. SIM 1 502 may transmit a message to request registration with the wireless network to the base station 504 via the allocated RF resource. For example, SIM 1 502 may transmit a registration request message that requests registration with the 5G network to the base station 504.

In operation 517, the base station 504 may transmit a message to accept the registration to SIM 1 502. For example, the base station 504 may transmit a registration accept message that accepts the registration with the 5G network to SIM 1 502. The base station 504 may register SIM 1 with the wireless network.

In operation 519, SIM 2 501 (e.g., the roaming SIM) may send a request to the CP 503 to allocate the RF resource. For example, SIM 2 501 may send a request to the CP 503 to allocate the RF resource because of cause 0 that has the RF priority of 7. For example, cause 0 may include a resource request to register SIM 1 502 with the mobile network.

In operation 521, the CP 503 may allocate the RF resource to SIM 2 501 in response to the resource allocation request of SIM 2 501.

In operation 523, SIM 2 501 may transmit a message to request registration of SIM 2 501 with the wireless network to the base station 504. SIM 2 501 may transmit a message to request registration with the wireless network to the base station 504 via the allocated RF resource. For example, SIM 2 501 may transmit a registration request message that requests registration with the 5G network to the base station 504.

In operation 525, the base station 504 may transmit a message to reject the registration to SIM 2 501. For example, the base station 504 may transmit the registration reject message that rejects the registration with the 5G network to SIM 2 501.

According to an embodiment, the base station 504 that receives the registration request message from SIM 2 501 may identify the roaming state and the roaming service for SIM 2. For example, the base station 504 may determine that SIM 2 corresponds to the roaming SIM and whether SIM 2 is subscribed to the roaming service. For example, the base station 402 may transmit the registration reject message to the electronic device 401 indicating that the registration of the roaming SIM has failed due to reject cause #29 of the 3GPP specification.

In operation 527, SIM 1 502 may request allocation of resources to CP 503. For example, SIM 1 502 may send a request to the CP 503 to allocate the RF resource because of cause 6 that has the RF priority of 1. For example, cause 6 may include a request for the RF resource to provide a data service to SIM 1 502. Herein, it is assumed that as the number increases, the RF priority increases.

In operation 529, the CP 503 may allocate the RF resource to SIM 1 502 in response to the resource allocation request of SIM 1 502.

In operation 531, SIM 1 502 may provide the data service by receiving the RF resource.

In operation 533, SIM 2 501 may send a request to the CP 503 to allocate the RF resource. Since the description provided in operation 519 above may be applied to operation 533, a detailed description thereof is omitted. Since SIM 2 501 requests resource allocation to register with the mobile network, the RF priority (e.g., 7) of the request of SIM 2 501 may be higher than the RF priority (e.g., 1) of SIM 1 502 to provide the data service.

In operation 535, the CP 503 may allocate the resource to SIM 2 501 in response to the resource allocation request of SIM 2 501. In DSDS, the RF resource may be provided to one SIM at a time. Since the RF priority of the request of SIM 2 501 is higher than the RF priority of SIM 1 502 to provide the data service, the RF resource may be allocated to SIM 2 501. As the RF resource is allocated to register SIM 2 501 with the mobile network, the resource allocation for the data service of SIM 1 502 may be canceled. The data service via SIM 1 502 may be suspended because the allocation of the RF resource to SIM 1 502 is canceled.

In operation 537, SIM 2 501 may transmit a message to request registration of SIM 2 501 with the wireless network to the base station 504.

In operation 539, the base station 504 may transmit a message to reject the registration to SIM 2 501. Since the description of operation 525 may be applied to operation 539, a detailed description thereof is omitted.

The RF priority for registration of SIM 2 501 with the mobile network may be higher than the RF priority of SIM 1 520 for the data service. Since the RF resource may be allocated to one SIM at a time, the allocation of the RF resource for the data service of SIM 1 502 may be deprioritized as the RF resource is iteratively allocated to SIM 2 to register SIM 2 501 with the mobile network. The communication performance provided by SIM 1 502 may be degraded because the allocation of the RF resource to SIM 1 502 is repeatedly interrupted by repeated registration attempts of SIM 2 501.

Hereinafter, a method of preventing and/or reducing degradation of the communication performance provided by SIM 1 502 by preventing and/or reducing repeated registration attempts of the roaming SIM (e.g., SIM 2 501) is described.

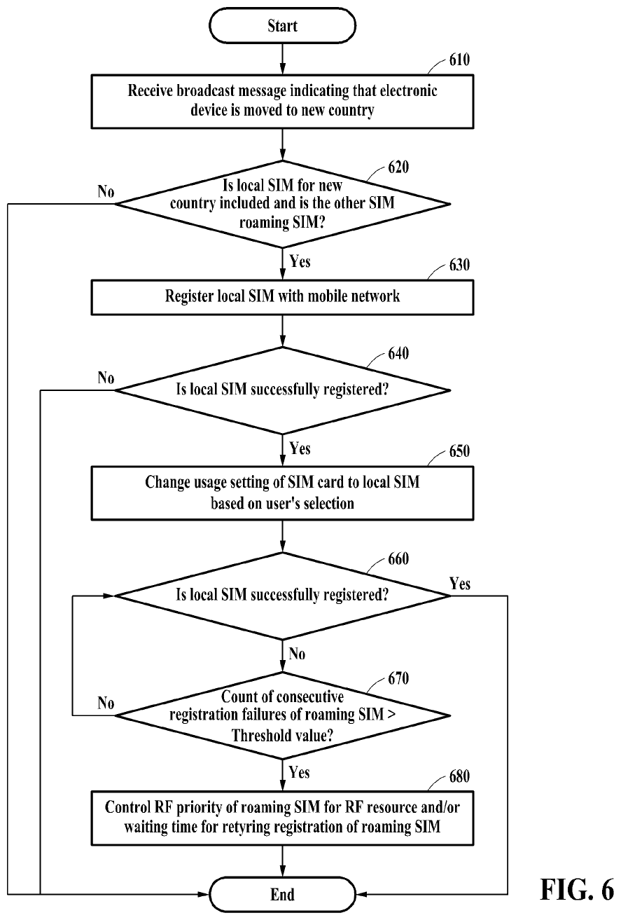

FIG. 6 is a diagram illustrating an operation of an electronic device according to an embodiment.

In the following embodiments, operations may be performed sequentially but not necessarily. For example, the order of the operations may change, and at least two of the operations may be performed in parallel. Operations 610 to 680 may be performed by at least one component of an electronic device (e.g., the electronic device 101 of FIG. 1, the electronic device 201 of FIG. 2, the electronic device 301 of FIG. 3, and the electronic device 401 of FIG. 4). For example, instructions stored in memory (e.g., the memory 130 of FIG. 1) may be collectively and/or individually executed by at least one processor (e.g., the processor 120 of FIG. 1 and the processor 210 of FIG. 2), and the instructions may cause the electronic device to perform operations 610 to 680 below.

In operation 610, the electronic device may receive a broadcast message indicating that the electronic device is moved to a new country.

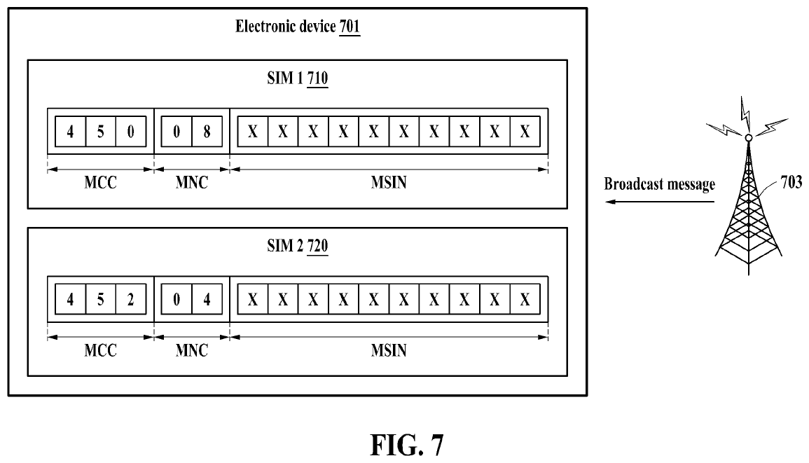

According to an embodiment, the electronic device may identify that the electronic device is moved to the new country based on mobile country code (MCC) included in the broadcast message. The MCC may include a unique number assigned to each country. For example, in the case of the Republic of Korea, the MCC may be “450”. A method of determining whether the electronic device is moved to a new country is described below with reference to FIG. 7.

In operation 620, the electronic device may determine whether the electronic device includes a local SIM (e.g., SIM 1 502 of FIG. 5) for the new country, and the other SIM is a roaming SIM (e.g., SIM 2 501 of FIG. 5).

According to an embodiment, the electronic device may include a device that supports DSDS. The electronic device may include two SIMs (e.g., SIM 1 and SIM 2) based on DSDS. According to an embodiment, the electronic device may determine whether one of the two SIMs is a SIM (e.g., the local SIM) issued by a carrier in the country where the electronic device is currently located and the other one is a SIM (e.g., the roaming SIM) issued by a foreign carrier, based on the broadcast message.

According to an embodiment, the electronic device may determine which one of the two SIMs is the local SIM and the other is the roaming SIM based on the MCC included in the broadcast message.

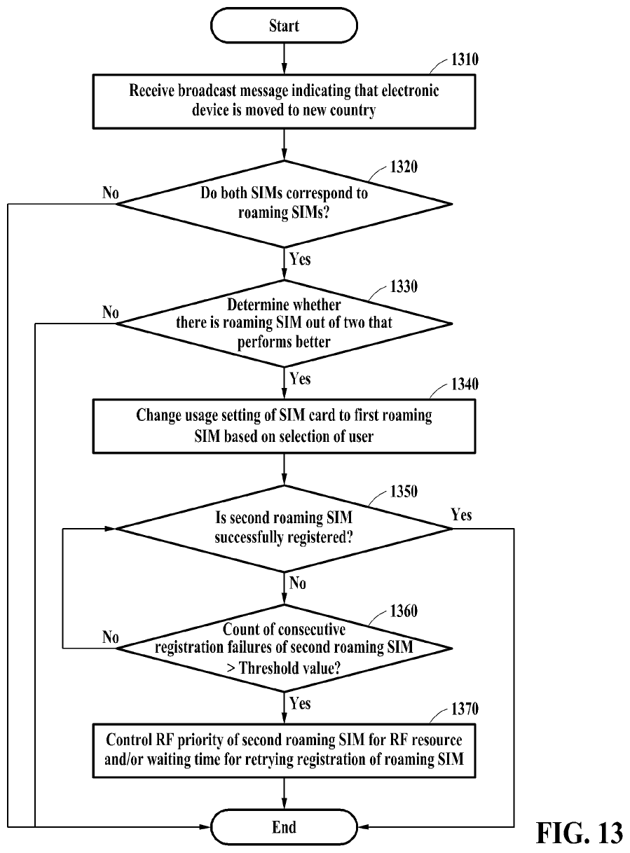

According to an embodiment, when one of the two SIMs is the local SIM and the other one is the roaming SIM, the electronic device may perform operation 630. When both SIMs are local SIMs, the electronic device may terminate operations of FIG. 6. When both SIMs are roaming SIMs, the electronic device may terminate operations of FIG. 6. The operation of the electronic device when both SIMs are roaming SIMs is described below with reference to FIG. 13.

In operation 630, the electronic device may perform registration of the local SIM with the mobile network (e.g., the second network 199 of FIG. 1, the first cellular network 292 of FIG. 2, and the second cellular network 294 of FIG. 2). The electronic device may perform registration of the local SIM with the mobile network based on operations 511 to 517 of FIG. 5.

In operation 640, the electronic device may determine whether the local SIM is successfully registered. The electronic device may determine whether the local SIM is successfully registered based on a message received from a base station (e.g., the base station 402 of FIG. 4 and the base station 504 of FIG. 5).

In operation 650, the electronic device may change the usage setting of a SIM card to the local SIM based on the user's selection.

According to an embodiment, when the electronic device is set to use the local SIM (e.g., the roaming SIM after the move) before the move, even though the electronic device is moved to a new country, the electronic device may notify that the local SIM has been changed via a user interface (UI).

According to an embodiment, the electronic device may receive a command to change the usage setting of the SIM card from a past local SIM to a current local SIM via the UI. The electronic device may change the usage setting of the SIM card to the current local SIM based on the received command.

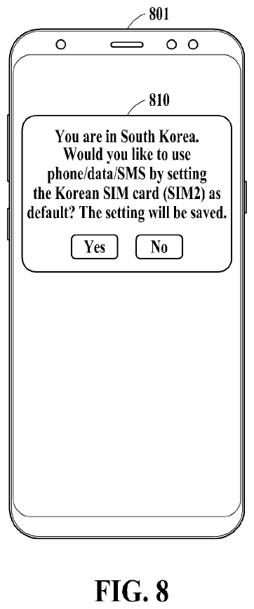

The UI described above is described below with reference to FIG. 8.

According to an embodiment, the electronic device may perform registration of the roaming SIM with the mobile network after the local SIM is registered. The electronic device may perform the registration of the roaming SIM based on operations 519 to 525 of FIG. 5.

According to an embodiment, operations 610 to 650 may be performed by at least one AP included in the electronic device. For example, instructions stored in memory may be collectively and/or individually executed by at least one AP, and the instructions may cause the electronic device to perform operations 610 to 650.

In operation 660, the electronic device may determine whether the roaming SIM is successfully registered. The electronic device may determine whether the roaming SIM is successfully registered based on the message received from the base station. For example, the electronic device may determine that the registration is successful when the registration accept message or the attach accept message with respect to the roaming SIM is received from the base station. For example, the electronic device may determine that the registration is rejected when the registration reject message and the attach reject message with respect to the roaming SIM is received from the base station.

According to an embodiment, when the roaming SIM is successfully registered, the electronic device may terminate the operation of FIG. 6. When the registration of the roaming SIM is rejected, the electronic device may perform operation 670.

In operation 670, the electronic device may determine whether a count of consecutive registration failures (e.g., a count of consecutive registration rejections) of the roaming SIM exceeds a threshold value.

According to an embodiment, when the count of consecutive registration failures of the roaming SIM does not exceed the threshold value, the electronic device may perform operation 660 again. The electronic device may iteratively perform operations 660 and 670 until the roaming SIM is successfully registered or the count of consecutive registration failures of the roaming SIM exceeds the threshold value. The electronic device may retry the registration of the roaming SIM until the roaming SIM is successfully registered or the count of consecutive registration failures of the roaming SIM exceeds the threshold value.

According to an embodiment, when the count of consecutive registration failures of the roaming SIM exceeds the threshold value, the electronic device may perform operation 680.

In operation 680, the electronic device may control the priority of the roaming SIM for the RF resource and/or a waiting time for retrying the registration of the roaming SIM.

According to an embodiment, the electronic device may decrease the priority of the roaming SIM for the RF resource. When the priority of the roaming SIM for the RF resource decreases and the RF priority for the registration of the roaming SIM becomes lower than the RF priority for the data service of the local SIM, the allocation of the RF resource allocated to the local SIM may not be canceled even if the registration of the roaming SIM is rejected.

According to an embodiment, the electronic device may increase the waiting time (e.g., the time of a timer (e.g., T3402 and T3502)) for retrying the registration of the roaming SIM. A frequency of retrying the registration of the roaming SIM may be reduced by increasing the waiting time for retrying the registration of the roaming SIM.

According to an embodiment, the electronic device may decrease the priority of the roaming SIM for the RF resource and may increase the waiting time for retrying the registration of the roaming SIM.

According to an embodiment, operations 660 to 680 may be executed by at least one CP (e.g., the CP 503 of FIG. 5) included in the electronic device. For example, instructions stored in memory may be collectively and/or individually executed by at least one CP, and the instructions may cause the electronic device to perform operations 660 to 680.

The electronic device may prevent and/or reduce cancellation of the allocation of the RF resource allocated to the local SIM or may decrease the frequency by controlling the waiting time and the RF priority of the roaming SIM. The electronic device may reduce power consumption due to repeated allocation of the RF resource and cancellation of allocation by controlling the RF priority of the roaming SIM and the waiting time.

Hereinafter, a method of determining whether the electronic device is located in a new country is described.

FIG. 7 is a diagram illustrating a method of determining whether a country that provides a mobile network is changed according to an embodiment.

Referring to FIG. 7, an electronic device 701 (e.g., the electronic device 101 of FIG. 1, the electronic device 201 of FIG. 2, the electronic device 301 of FIG. 3, and the electronic device 401 of FIG. 4) is illustrated. The electronic device 701 may include a device that supports DSDS. The electronic device may include two SIMs (e.g., SIM 1 710 and SIM 2 720) based on DSDS.

According to an embodiment, each SIM may include an IMSI. The IMSI may be used to identify a user in a mobile network (e.g., the second network 199 of FIG. 1, the first cellular network 292 of FIG. 2, and the second cellular network 294 of FIG. 2). The IMSI may include an MCC, a mobile network code (MNC), and a mobile subscription identification number (MSIN). The MCC may be mobile country code and may include a three-digit unique code for identifying a country. For example, the MCC of Republic of Korea may be “450”, and the MCC of Vietnam may be “452”. The MNC may include a two-digit or three-digit unique code for identifying a carrier that provides a mobile network service. For example, the MCN of carrier A may be “08”, and the MCN of carrier B may be “04”. The MSIN may include a unique code for identifying a SIM.

For example, the MCC and MNC of SIM 1 710 may be “450” and “08”, respectively, and may indicate that the SIM 1 710 is issued by carrier A in the Republic of Korea. The MCC and MNC of SIM 2 702 may be “452” and “04”, respectively, and may indicate that SIM 2 702 is issued by carrier B in Vietnam.

Hereinafter, it is assumed the electronic device 701 is currently located in the Republic of Korea.

According to an embodiment, the electronic device 701 may communicate with a base station 703 (e.g., the base station 402 of FIG. 4 and the base station 504 of FIG. 5). The electronic device 701 may receive a broadcast message from the base station 703. The broadcast message may include a network identifier (e.g., the MCC and the MNC), a location area code (LAC), a cell identifier (ID), and network status information.

According to an embodiment, the electronic device 701 may determine a local SIM and a roaming SIM based on the MCC included in the broadcast message. Herein, it is assumed that the MCC included in the broadcast message is “450”.

According to an embodiment, the electronic device 701 may compare the MCC included in the broadcast message with the MCC of each SIM. As a result of the comparison, if the MCCs are the same, the electronic device 701 may determine that the SIM is a local SIM and if not, the electronic device 701 may determine that the SIM is a roaming SIM. For example, SIM 1 710 may be determined to be a local SIM (e.g., SIM 1 502 of FIG. 5) and SIM 2 720 may be determined to be a roaming SIM (e.g., SIM 2 501 of FIG. 5).

Even when the SIM 1 710 is determined to be the local SIM, SIM 2 720 may be set as a default SIM card. The default SIM card may be a SIM that is connected, directly or indirectly, to the mobile network and is set to provide a service to the electronic device 701. For example, when the electronic device 701 was previously located in Vietnam and is currently located in the Republic of Korea, even though SIM 1 710 is determined to be the local SIM, SIM 2 720 may be set as the default SIM card. When SIM 2 720 is not subscribed to the roaming service, the electronic device 701 may not be provided with a service (e.g., a phone call, an SMS, and a data service) via the mobile network. Accordingly, the default SIM card may need to be changed.

FIG. 8 is a diagram illustrating a UI that notifies that a local SIM is changed according to an embodiment.

Referring to FIG. 8, an electronic device 801 (e.g., the electronic device 101 of FIG. 1, the electronic device 201 of FIG. 2, the electronic device 301 of FIG. 3, the electronic device 401 of FIG. 4, and the electronic device 701 of FIG. 7) is illustrated.

According to an embodiment, the electronic device 801 may identify that a location of the electronic device 801 is changed based on a broadcast message received from a base station (e.g., the base station 402 of FIG. 4 and the base station 504 of FIG. 5). For example, the electronic device 801 may identify that the electronic device 801 is currently located in the Republic of Korea based on the broadcast message.

Hereinafter, it is assumed that even though SIM 2 is determined to be a local SIM (e.g., SIM 1 502 of FIG. 5) as the location of the electronic device 801 is changed to the Republic of Korea, SIM 1 that is a roaming SIM (e.g., SIM 2 501 of FIG. 5) is set to the SIM card according to the previous settings.

According to an embodiment, when the electronic device is set to use the local SIM before the move (e.g., the roaming SIM after the move), even though the electronic device 801 is moved to a new country, the electronic device 801 may notify that the local SIM has been changed via a UI 810. For example, the electronic device may notify that the local SIM has been changed via a display module (e.g., the display module 160 of FIG. 1).

According to an embodiment, the UI 810 may further display buttons for obtaining a control command from the user. The electronic device 801 may obtain a control command to change the default SIM card to the local SIM via the buttons. The electronic device 801 may change the default SIM card to the local SIM based on the control command. As the default SIM card is changed to the local SIM, the electronic device may provide a mobile network service (e.g., the second network 199 of FIG. 1, the first cellular network 292 of FIG. 2, and the second cellular network 294 of FIG. 2) to the user via the local SIM.

For example, when the electronic device identifies that the location of the electronic device 801 is changed to the Republic of Korea, the electronic device 801 may display the UI 810 on the display module. The UI 810 may display a phrase, “You are in South Korea. Would you like to use phone/data/SMS by setting the Korean SIM card (SIM 2) as the default? The setting will be saved”. The electronic device 801 may change the default SIM card to the local SIM by the user via a button displaying “YES”.

According to an embodiment, the electronic device 801 may save the changed default SIM card setting. Unless the location of the electronic device 801 is changed to another country, the electronic device 801 may use the local SIM corresponding to the currently located country as the default SIM card by loading the saved settings. For example, when the electronic device 801 is rebooted, the electronic device 801 may use the local SIM corresponding to the current country as the default SIM card based on the saved settings.

The electronic device 801 may provide the calling, SMS, and data services to the user via the local SIM by changing the local SIM to the default SIM in response to the control command of the user.

Hereinafter, an operation of the electronic device 801 to control the RF priority of the roaming SIM for the RF resource or the waiting time to retry the registration of the roaming SIM is described.

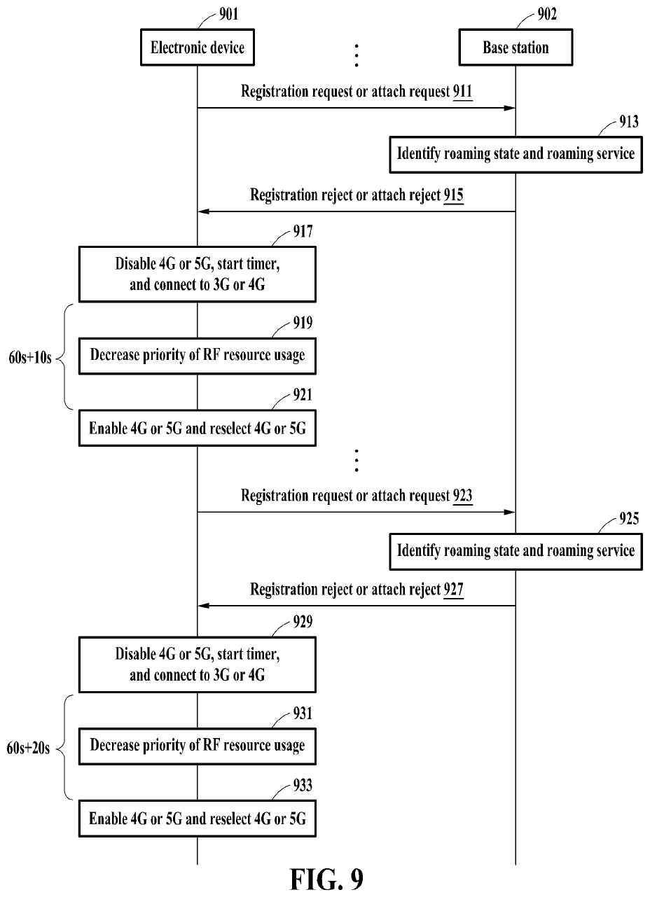

FIG. 9 is a diagram illustrating an operation between an electronic device and a base station according to an embodiment.

Referring to FIG. 9, a flowchart for illustrating an operation between an electronic device 901 (e.g., the electronic device 101 of FIG. 1, the electronic device 201 of FIG. 2, the electronic device 301 of FIG. 3, the electronic device 401 of FIG. 4, the electronic device 701 of FIG. 7, and the electronic device 801 of FIG. 8) and a base station 902 (e.g., the base station 402 of FIG. 4 and the base station 504 of FIG. 5) is illustrated.

In the following embodiments, operations may be performed sequentially but not necessarily. For example, the order of the operations may change, and at least two of the operations may be performed in parallel. At least some of operations 911 to 933 may be performed by at least one component of the electronic device 901. For example, instructions stored in memory (e.g., the memory 130 of FIG. 1) may be collectively and/or individually executed by at least one processor (e.g., the processor 120 of FIG. 1 and the processor 210 of FIG. 2), and the instructions may cause the electronic device to perform at least some of operations 911 to 933 below.

Prior to operation 911, it is assumed that registrations of a roaming SIM (e.g., SIM 2 501 of FIG. 5) with a mobile network (e.g., the second network 199 of FIG. 1, the first cellular network 292 of FIG. 2, and the second cellular network 294 of FIG. 2) are consecutively rejected, and a count of consecutive registration rejections is a threshold value.

In operation 911, the electronic device 901 may transmit, to the base station 902, a message to request registration of a roaming SIM with a wireless network.

In operation 913, the base station 902 that receives the message may identify a roaming state and a roaming service for the roaming SIM.

In operation 915, the base station 902 may transmit a registration reject message to the electronic device 901.

In operation 917, the electronic device 401 may disable 4G or 5G. The electronic device 401 may start a timer for a re-registration attempt.

Since the description of operations 400 to 440 of FIG. 4 may be applied to operations 911 to 917, a detailed description thereof is omitted.

In operation 919, the electronic device may decrease the RF priority indicating the priority of the roaming SIM to use the RF resource. Since the registrations of the roaming SIM with the mobile network are already rejected consecutively by the threshold value prior to operation 911, the count of consecutive registration rejections due to rejections in operations 911 to 915 may exceed the threshold value. Since the count of consecutive registration rejections exceeds the threshold value, the electronic device 901 may control the priority (e.g., the RF priority) of the roaming SIM for the RF resource and/or a waiting time for retrying the registration of the roaming SIM.

According to an embodiment, the electronic device 901 may differently determine a decrement based on a rejection cause of the registration of the roaming SIM. The electronic device 901 may decrease the RF priority of the roaming SIM based on the determined decrement.

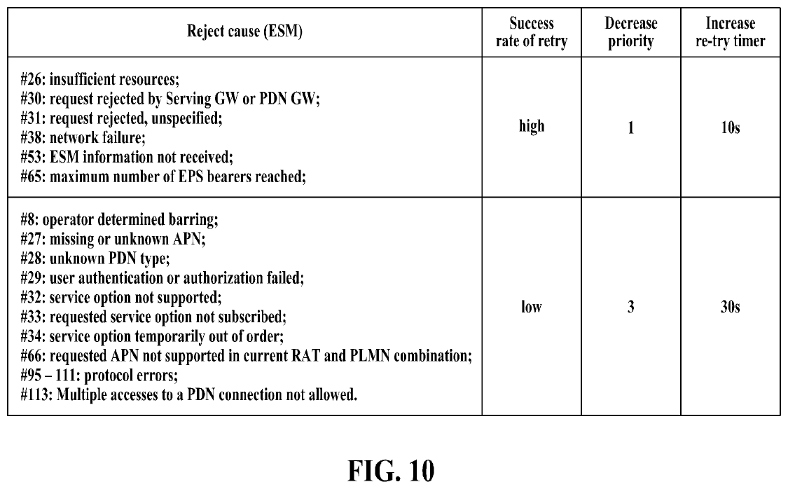

A method of differently determining a decrement based on a rejection cause by the electronic device 901 is described below with reference to FIG. 10.

According to an embodiment, the electronic device 901 may increase the waiting time (e.g., the timer (e.g., T3402 and T3502)) for retrying the registration of the roaming SIM. For example, when an initial value of the waiting time of the roaming SIM is 60 seconds(s), the electronic device 901 may control the waiting time to 70 s by adding an offset (e.g., an increment) (e.g., 10 s) to the initial value.

According to an embodiment, the electronic device 901 may differently determine the increment of the waiting time based on the rejection cause of the registration of the roaming SIM. The electronic device 901 may increase the waiting time based on the determined increment.

The control of the waiting time of the electronic device 901 is described below with reference to FIG. 10.

In operation 921, the electronic device 901 may re-attempt the registration by activating the 4G or 5G function for the roaming SIM and reselecting 4G or 5G. Since the description of operation 440 of FIG. 4 may apply to operation 921, a detailed description thereof is omitted.

The electronic device 901 may retry the registration of the roaming SIM based on the determined RF priority of the roaming SIM and the determined waiting time in operation 919. Hereinafter, prior to operation 923, it is assumed that the registrations of the roaming SIM are consecutively rejected based on the determined RF priority of the roaming SIM and the determined waiting time in operation 919, and the count of consecutive registration rejections is a threshold value.

Since the descriptions of operations 400 to 440 of FIG. 4 and operations 911 to 917 of FIG. 9 may apply to the description of operations 923 to 929, a detailed description thereof is omitted.

In operation 931, the electronic device 901 may decrease the RF priority indicating the priority of the roaming SIM to use the RF resource. Since the registrations of the roaming SIM with the mobile network are already rejected consecutively by the threshold value prior to operation 923, the count of consecutive registration rejections due to rejections in operations 923 to 929 may exceed the threshold value. Since the count of consecutive registration rejections exceeds the threshold value, the electronic device 901 may control the priority (e.g., the RF priority) of the roaming SIM for the RF resource and/or a waiting time for retrying the registration of the roaming SIM.

In operation 931, the RF priority of the roaming SIM may be lowered than that in operation 919 by decreasing the RF priority of the roaming SIM.

According to an embodiment, the electronic device 901 may increase the waiting time for retrying the registration of the roaming SIM. For example, the waiting time may be controlled to 80 s by adding 10 s to the waiting time 70 s of the roaming SIM.

According to an embodiment, the electronic device 901 may iteratively perform the operations described above until the roaming SIM is successfully registered. The electronic device 901 may iteratively perform registration of the roaming SIM until the priority related to the registration among the RF priorities of the roaming SIM becomes lower than the priority related to the data service among the RF priorities of the local SIM (e.g., SIM 1 502 of FIG. 5).

Hereinafter, the control of the roaming SIM with respect to the RF priority and the control of waiting time are described.

FIG. 10 is a diagram illustrating an increase amount of a waiting time based on a rejection cause and a decrement of an RF priority according to an embodiment.

According to an embodiment, an electronic device (e.g., the electronic device 101 of FIG. 1, the electronic device 201 of FIG. 2, the electronic device 301 of FIG. 3, the electronic device 401 of FIG. 4, the electronic device 701 of FIG. 7, the electronic device 801 of FIG. 8, and the electronic device 901 of FIG. 9) may differently determine a decrement based on a rejection cause of registration of a roaming SIM (e.g., SIM 2 501 of FIG. 5). The electronic device may decrease an RF priority based on the determined decrement.

According to an embodiment, the electronic device may determine a first decrement (e.g., 3) when a rejection cause is included in a first rejection cause to be greater than a second decrement (e.g., 1) when the rejection cause is included in a second rejection cause.

According to an embodiment, the first rejection cause may include a rejection cause that is more difficult to be resolved than the second rejection cause. The first rejection cause may include a more severe rejection cause than the second rejection cause.

According to an embodiment, the first rejection cause may include a rejection cause based on a problem that may persist longer than the second rejection cause. The second rejection cause may include a temporary rejection cause.

According to an embodiment, the first rejection cause may include rejection causes that are unlikely to be resolved when retrying the registration. The second rejection cause may include rejection causes that are highly likely to be resolved when retrying the registration. The second rejection cause may include rejection causes that are more likely to be resolved than the first rejection cause when retrying the registration. The first rejection cause may include a rejection cause of which the probability of being resolved is less than a threshold probability when retrying the registration. The second rejection cause may include a rejection cause of which the probability of being resolved is greater than or equal to the threshold probability when retrying the registration.

For example, the first rejection cause may include Reject causes #8, #27, #28, #29, #32, #33, #34, #66, #95 to 111, and #113 of the 3GPP standard specification. Reject cause #8 may occur because a network operator (e.g., a carrier) prohibits the provision of or connection to a mobile network (e.g., the second network 199 of FIG. 1, the first cellular network 292 of FIG. 2, and the second cellular network 294 of FIG. 2) for a specific user or a specific group. Reject cause #27 may occur because an access point name (APN) is missing or is not recognized. Reject cause #28 may occur when a packet data network (PDN) type is not recognized by the network. Reject cause #29 may occur when authorization and authentication to verify whether the user is authorized have failed. Reject cause #32 may occur when a requested service is not supported by the network. Reject cause #33 may occur when a requested service option is not included in a service contract of the user. Reject cause #34 may occur when a requested service option is temporarily unavailable. Reject cause #66 may occur when a requested APN is not supported by a combination of currently used wireless connection technology (e.g., radio access technology (RAT)) and a public land mobile network (PLMN). Reject causes #95 to 111 may occur due to protocol errors. Reject cause #113 may occur when multiple accesses to the same PDN connection are not allowed.

For example, the second rejection cause may include Reject cause #26, #30, #31, #38, #53, and #65 of the 3GPP standard specification. Reject cause #26 may occur when a requested task cannot be performed due to insufficient network resources. Reject cause #30 may occur when a request is rejected by a serving gateway or a PDN gateway. Reject cause #31 may occur when a request is rejected for an unidentified cause. Reject cause #38 may occur when a specific element of the network does not function or when a request is not processed due to a problem in the network. Reject cause #53 may occur when enhanced service mobility (ESM) information is not received. Reject cause #65 may occur when the maximum number of evolved packet system (EPS) bearers is reached.

For example, when the rejection cause of the registration is included in the first rejection cause, the RF priority of the roaming SIM may decrease by 3. When the rejection cause of the registration is included in the second rejection cause, the RF priority of the roaming SIM may decrease by 1.

According to an embodiment, the electronic device may decrease the priority with respect to all items included in the RF priority.

A loop for re-registration of the roaming SIM when the first rejection cause has occurred may be shorter than a loop for registration of the roaming SIM when the second rejection cause has occurred by determining the first decrement of the first rejection cause to be greater than the second decrement of the second rejection cause. When the registration is rejected for the first rejection cause, an attempt to re-register the roaming SIM may be terminated more rapidly than when the registration is rejected for the second rejection cause.

In the case of a rejection cause that is difficult to be resolved or takes a long time to be resolved, unnecessary repeated attempts to register the roaming SIM may be prevented and/or reduced at least by determining the first decrement of the first rejection cause to be greater than the second decrement of the second rejection cause.

According to an embodiment, the electronic device may differently determine an increment of the waiting time based on a rejection cause of the registration of the roaming SIM. The electronic device may increase the waiting time based on the determined increment.

According to an embodiment, the electronic device may determine a first increment (e.g., 30 s) when the rejection cause is included in the first rejection cause to be greater than a second increment (e.g., 10 s) when the rejection cause is included in the second rejection cause.

For example, when the rejection cause of the registration is included in the first rejection cause, the waiting time may increase by 30 s. When the rejection cause of the registration is included in the second rejection cause, the waiting time may increase by 10 s.

An attempt to retry the registration of the roaming SIM when the first rejection cause has occurred may occur less frequently than an attempt to retry the registration of the roaming SIM when the second rejection cause has occurred by determining the first increment of the first rejection cause to be greater than the second increment of the second rejection cause.

A frequency of cancellation of RF resource allocation to the local SIM may decrease as the attempt to retry the registration of the roaming SIM less frequently occurs when the first rejection cause has occurred.

Hereinafter, initialization of the RF priority and the waiting time is described.

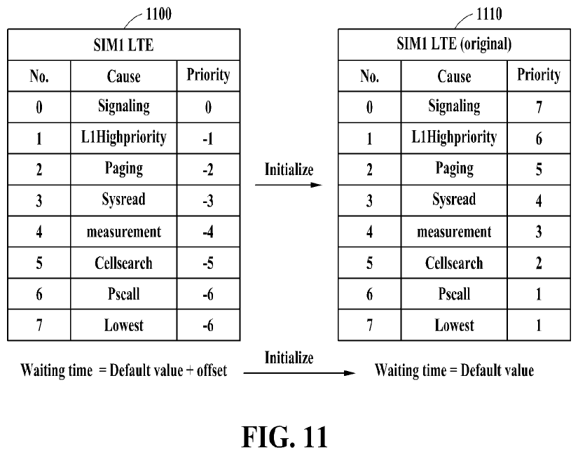

FIG. 11 is a diagram illustrating initialization of an RF priority and a waiting time according to an embodiment.

Referring to FIG. 11, RF priority lists 1100 and 1110 indicating priorities of RF resource usage of a roaming SIM (e.g., SIM 2 501 of FIG. 5) are illustrated. In FIG. 11, it is assumed that SIM 1 is a roaming SIM.

According to an embodiment, the RF priority list 1100 may indicate that the priority of RF resource usage decreases due to repeated registration rejections of the roaming SIM. The RF priority list 1110 may indicate an initial priority of the roaming SIM for the RF resource usage. For example, the RF priority list 1110 may be controlled by the RF priority list 1100 due to repeated registration rejections of the roaming SIM.

According to an embodiment, referring to each item of the RF priority list 1100, requests of the roaming SIM for RF resources for a specific operation and an RF priority thereof are provided. For example, in the RF priority list 1110, #0 Signaling may be a request for an RF resource to exchange a signal with the network for registration, authentication, and a service request and may have an RF priority of 7. In the RF priority list 1110, #1 L1Highpriority may be a request for an RF resource to process a high priority request operation in layer 1 and may have an RF priority of 6. In the RF priority list 1110, #2 Paging may be a request for an RF resource to decode a page message and may have an RF priority of 5. In the RF priority list 1110, #3 Sysread may be a request for an RF resource to decode a broadcast message and may have an RF priority of 4. In the RF priority list 1110, #4 measurement may be a request for an RF resource to measure a cell signal and may have an RF priority of 3. In the RF priority list 1110, #5 Cellsearch may be a request for an RF resource to trigger a cell search and may have an RF priority of 2. In the RF priority list 1110, #6 Pscall may be a request for an RF resource for a data service and may have an RF priority of 1. In the RF priority list 1110, #7 Lowest may be for lowest priority allocation and may have an RF priority of 1. As the number corresponding to the RF priority increases, the allocation order of RF resources may increase. For example, even though the RF resource is allocated to the local SIM by #6 Pscall, when a request of the roaming SIM by #1 signaling is received, the RF resource may be provided to the roaming SIM.

According to an embodiment, the waiting time may increase due to repeated registration rejections of the roaming SIM. For example, the waiting time due to repeated registration rejections of the roaming SIM may be determined to be a sum of a default value and an offset. The offset may be determined to be the product of a decrement and the number of loops. A count of waiting time controls as a count of consecutive registration failures of the roaming SIM exceeds a threshold value may correspond to the number of loops.

For example, when the count of consecutive registration failures exceeding the threshold value is 3 and the decrement is 30 s, the waiting time may be determined to be the sum of the default value and 90 s.

According to an embodiment, an electronic device (e.g., the electronic device 101 of FIG. 1, the electronic device 201 of FIG. 2, the electronic device 301 of FIG. 3, the electronic device 401 of FIG. 4, the electronic device 701 of FIG. 7, the electronic device 801 of FIG. 8, and the electronic device 901 of FIG. 9) may initialize the RF priority list 1100 and the waiting time.

According to an embodiment, when the roaming SIM is successfully registered, the electronic device may initialize the RF priority list 1100 and the waiting time.

According to an embodiment, when a registration attempt of the roaming SIM is disabled, the electronic device may initialize the RF priority list 1100 and the waiting time.

According to an embodiment, when a PLMN of the roaming SIM is changed, the electronic device may initialize the RF priority list 1100 and the waiting time.

According to an embodiment, when DSDS switching occurs, the electronic device may initialize the RF priority list 1100 and the waiting time. For example, when the default SIM card is changed to the other SIM, the electronic device may initialize the RF priority list 1100 and the waiting time.

According to an embodiment, when the SIM is changed, the electronic device may initialize the RF priority list 1100 and the waiting time.

According to an embodiment, when the electronic device is rebooted, the electronic device may initialize the RF priority list 1100 and the waiting time.

When the RF priority list 1100 and the waiting time are initialized, the electronic device may perform the registration of the roaming SIM with the RF priority list 1110 and the waiting time (e.g., the default value).

Hereinafter, a method of terminating repeated registration attempts of the roaming SIM with the mobile network by controlling the RF priority lists 1100 and 1110 is described.

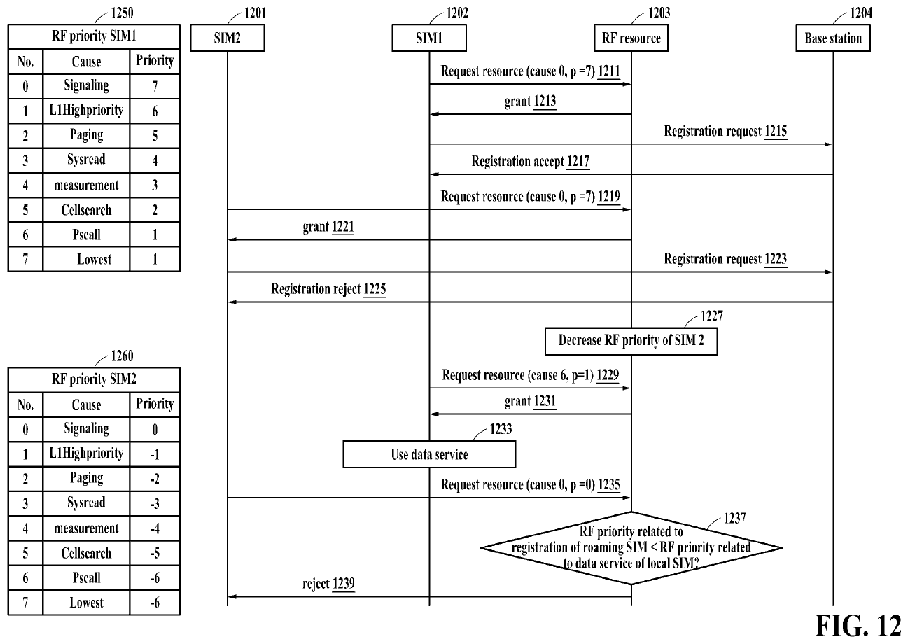

FIG. 12 is a diagram illustrating an operation between an electronic device and a base station according to an embodiment.

Referring to FIG. 12, SIM 2 1201 (e.g., SIM 2 501 of FIG. 1), SIM 1 1202 (e.g., SIM 1 502 of FIG. 5), a CP 1203 (e.g., the CP 503 of FIG. 5), and a base station 1204 (e.g., the base station 402 of FIG. 4, the base station 504 of FIG. 5, and the base station 703 of FIG. 3) are illustrated. SIM 2 1201, SIM 1 1202, and the CP 1203 may be included in an electronic device (e.g., the electronic device 101 of FIG. 1, the electronic device 201 of FIG. 2, the electronic device 301 of FIG. 3, the electronic device 401 of FIG. 4, the electronic device 701 of FIG. 7, the electronic device 801 of FIG. 8, and the electronic device 901 of FIG. 9). The electronic device may include a device that supports DSDS. Hereinafter, it is assumed that SIM 2 1201 is a roaming SIM, and SIM 1 1202 is a local SIM. Hereinafter, it is assumed that SIM 2 1201 does not provide a roaming service because, for example, SIM 2 1202 is not subscribed to the roaming service.

According to an embodiment, an RF priority list 1250 may be an RF priority list of SIM 1 1202, an RF priority list 1260 (e.g., the RF priority lists 1100 and 1110 of FIG. 11) may be an RF priority list of SIM 2 1201. Since the descriptions of the RF priority lists 1250 and 1260 are provided above with reference to FIG. 11, the descriptions are omitted.

In the following embodiments, operations may be performed sequentially but not necessarily. For example, the order of the operations may change, and at least two of the operations may be performed in parallel. At least some of operations 1211 to 1239 may be performed by at least one component of the electronic device. For example, instructions stored in memory (e.g., the memory 130 of FIG. 1) may be collectively and/or individually executed by at least one processor (e.g., the processor 120 of FIG. 1 and the processor 210 of FIG. 2), and the instructions may cause the electronic device to perform at least some of operations 1211 to 1239 below.

Since the descriptions of operations 1211 to 1225 are provided above with reference to operations 511 to 525 of FIG. 5, a detailed description thereof is omitted.

It is assumed that the RF priority list 1260 is a decreased priority by operation 1227. It is assumed that registrations of SIM 2 (e.g., the roaming SIM) with a mobile network (e.g., the second network 199 of FIG. 1, the first cellular network 292 of FIG. 2, and the second cellular network 294 of FIG. 2) are consecutively rejected by operations 1219 to 1225 prior to operation 1227, and a count of consecutive registration rejections exceeds a threshold value.

In operation 1227, the electronic device may decrease the priority of SIM 2 1201. The electronic device may obtain the RF priority list 1260 by decreasing the priority of SIM 2 1201.

According to an embodiment, the electronic device may differently determine a decrement of the priority based on a rejection cause. Since the method of differently determining a decrement of the priority based on a rejection cause is described above with reference to FIG. 10, the description thereof is omitted.

In operation 1229, SIM 1 1202 may send a request to the CP 1203 to allocate resources. For example, SIM 1 1202 may send a request to the CP 1203 to allocate the RF resource because of cause 6 (e.g., Pscall) having an RF priority of 1.

In operation 1231, the CP 1203 may allocate the RF resource to SIM 1 1202 in response to the request of SIM 1 1202 for resource allocation.

In operation 1233, SIM 1 1202 may provide a data service by receiving the RF resource.

In operation 1235, SIM 2 1201 may request allocation of the RF resource to the CP 1203. For example, SIM 2 1201 may send a request to the CP 1203 to allocate the RF resource because of cause 0 (e.g., signaling) having an RF priority of 0.

According to an embodiment, SIM 2 1201 may perform operation 1235 after the waiting time is terminated according to the rejection in operation 1225.

In operation 1237, the CP 1203 may determine whether the RF priority (e.g., the RF priority of 0 for cause 0 in the RF priority list 1260) related to the registration of SIM 2 1201 (e.g., the roaming SIM) is less than the RF priority (e.g., the RF priority of 1 for cause 6 in the RF priority list 1250) related to the data service of SIM 1 1202 (e.g., the local SIM). For example, the CP 1203 may determine whether the priority (e.g., the priority of signaling) related to the registration of the roaming SIM in the RF priority list 1260 is less than the RF priority (e.g., the priority of Pscall) related to the data service of the local SIM.

According to an embodiment, when the RF priority related to the registration of SIM 2 1201 is greater than or equal to the RF priority related to the data service of SIM 1 1202, the CP 1203 may allocate the RF resource to SIM 2. SIM 2 that receives the RF resource may send a request to the base station 1204 for registration with the mobile network.

According to an embodiment, when the RF priority related to the registration of SIM 2 1201 is less than the RF priority related to the data service of SIM 1 1202, the CP 1203 may reject the request of SIM 2.

Repeated registration requests of SIM 2 1201 may be terminated by rejecting the request of SIM 2 1201. The degradation of communication performance between SIM 1 1202 and the mobile network may be prevented and/or reduced by terminating the repeated registration requests of SIM 2 1201.

FIG. 13 is a diagram illustrating an operation of an electronic device when both SIMs are roaming SIMs according to an embodiment.

In the following embodiments, operations may be performed sequentially but not necessarily. For example, the order of the operations may change, and at least two of the operations may be performed in parallel. Operations 1310 to 1370 may be performed by at least one component of an electronic device (e.g., the electronic device 101 of FIG. 1, the electronic device 201 of FIG. 2, the electronic device 301 of FIG. 3, the electronic device 401 of FIG. 4, the electronic device 701 of FIG. 7, the electronic device 801 of FIG. 8, and the electronic device 901 of FIG. 9). For example, instructions stored in memory (e.g., the memory 130 of FIG. 1) may be collectively and/or individually executed by at least one processor (e.g., the processor 120 of FIG. 1 and the processor 210 of FIG. 2), and the instructions may cause the electronic device to perform operations 1310 to 1370 below.

In operation 1310, the electronic device may receive a broadcast message indicating that the electronic device is moved to a new country.

According to an embodiment, the electronic device may identify that the electronic device is moved to the new country based on an MCC included in the broadcast message.

In operation 1320, the electronic device may determine whether both SIMs correspond to roaming SIMs (e.g., SIM 2 501 of FIG. 5 and SIM 2 1201 of FIG. 12).

According to an embodiment, when MCCs of both SIMs are different from the MCC included in the broadcast message, the electronic device may determine that both SIMs are roaming SIMs.

According to an embodiment, when both SIMs do not correspond to roaming SIMs, the electronic device may terminate the operation of FIG. 13. When it is determined that one of two SIMs is a local SIM (e.g., SIM 1 502 of FIG. 5 and SIM 1 1202 of FIG. 12) and the other one is a roaming SIM, the electronic device may perform operation 630 and the following operations of operation 630 in FIG. 6.

In operation 1330, the electronic device may determine whether there is a roaming SIM out of the two that performs better (e.g., the first roaming SIM and the second roaming SIM).

According to an embodiment, the electronic device may assess throughput speed, signal conditions, and call technology of two roaming SIMs. Based on an assessment result, the electronic device may determine whether there is a roaming SIM out of the two that performs better. For example, it is assumed that the performance of the first roaming SIM is better.

In operation 1340, the electronic device may change the usage setting of a SIM card to the first roaming SIM based on a selection of a user.

According to an embodiment, the electronic device may display a UI on a display module (e.g., the display module 160 of FIG. 1) for notifying the user that the first roaming SIM has the better performance and receiving a command to change the default SIM card to the first roaming SIM.

According to an embodiment, the electronic device may change the first roaming SIM as the default SIM card in response to the received command.

According to an embodiment, the electronic device may register the second roaming SIM with the mobile network after registering the first roaming SIM. The electronic device may register the second roaming SIM based on operations 519 to 525 of FIG. 5 and operations 1219 to 1225 of FIG. 12.

In operation 1350, the electronic device may determine whether the second roaming SIM is successfully registered. The electronic device may determine whether the second roaming SIM is successfully registered based on a message received from a base station (e.g., the base station 402 of FIG. 4, the base station 504 of FIG. 5, the base station 703 of FIG. 7, and the base station 1204 of FIG. 12).

According to an embodiment, when the second roaming SIM is successfully registered, the electronic device may terminate the operations of FIG. 13. When the registration of the second roaming SIM is rejected, the electronic device may perform operation 1360.

In operation 1360, the electronic device may determine whether a count of consecutive registration failures (e.g., a count of consecutive registration rejections) of the second roaming SIM exceeds a threshold value.

According to an embodiment, when the count of consecutive registration failures of the second roaming SIM does not exceed the threshold value, the electronic device may perform operation 1350 again. The electronic device may iteratively perform operations 1350 and 1360 until the second roaming SIM is successfully registered or the count of consecutive registration failures of the second roaming SIM exceeds the threshold value. The electronic device may retry the registration of the roaming SIM until the second roaming SIM is successfully registered or the count of consecutive registration failures of the second roaming SIM exceeds the threshold value.

According to an embodiment, when the count of consecutive registration failures of the second roaming SIM exceeds the threshold value, the electronic device may perform operation 1370.

In operation 1370, the electronic device may control the priority of the second roaming SIM for the RF resource and/or a waiting time for retrying the registration of the second roaming SIM.

According to an embodiment, the electronic device may decrease the priority of the second roaming SIM for the RF resource. When the priority of the second roaming SIM for the RF resource decreases and the RF priority for the registration of the second roaming SIM becomes lower than the RF priority for the data service of the first roaming SIM, the allocation of the RF resource to the first roaming SIM may not be canceled, even if the registration of the second roaming SIM is rejected.

According to an embodiment, the electronic device may increase the waiting time (e.g., the time of a timer (e.g., T3402 and T3502)) for retrying the registration of the second roaming SIM. A frequency of retrying the registration of the second roaming SIM may be reduced by increasing the waiting time for retrying the registration of the second roaming SIM.

According to an embodiment, the electronic device may decrease the priority of the second roaming SIM for the RF resource and may increase the waiting time for retrying the registration of the second roaming SIM.

The electronic device may prevent cancellation of the allocation of the RF resource to the first roaming SIM or may decrease the frequency by controlling the waiting time and the RF priority of the second roaming SIM. The electronic device may reduce power consumption due to repeated allocation of the RF resource and cancellation of allocation by controlling the RF priority of the second roaming SIM and the waiting time.

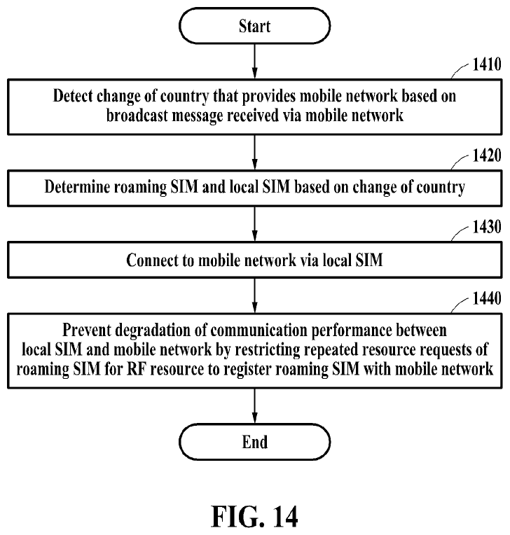

FIG. 14 is a flowchart illustrating an operating method of an electronic device according to an embodiment.

In the following embodiments, operations may be performed sequentially but not necessarily. For example, the order of the operations may change, and at least two of the operations may be performed in parallel. Operations 1410 to 1420 may be performed by at least one component of an electronic device (e.g., the electronic device 101 of FIG. 1, the electronic device 201 of FIG. 2, the electronic device 301 of FIG. 3, the electronic device 401 of FIG. 4, the electronic device 701 of FIG. 7, the electronic device 801 of FIG. 8, and the electronic device 901 of FIG. 9). For example, instructions stored in memory (e.g., the memory 130 of FIG. 1) may be collectively and/or individually executed by at least one processor (e.g., the processor 120 of FIG. 1 and the processor 210 of FIG. 2), and the instructions may cause the electronic device to perform operations 1410 to 1440 below.

In operation 1410, the electronic device may detect a change of a country that provides a mobile network based on a broadcast message received via the mobile network (e.g., the second network 199 of FIG. 1, the first cellular network 292 of FIG. 2, and the second cellular network 294 of FIG. 2).

In operation 1420, the electronic device may determine a roaming SIM (e.g., SIM 2 501 of FIG. 5 and SIM 2 1201 of FIG. 12) and a local SIM (e.g., SIM 1 502 of FIG. 5 and SIM 1 1202 of FIG. 12) based on the change of country.

In operation 1430, the electronic device may be connected to the mobile network via the local SIM.

In operation 1440, the electronic device may prevent and/or reduce the degradation of communication performance between the local SIM and the mobile network by restricting repeated resource requests of the roaming SIM for the RF resource to register the roaming SIM with the mobile network.

Since the description of operations 1410 to 1440 is provided above with reference to FIGS. 1 to 13, a detailed description thereof is omitted.

According to an embodiment, the electronic device may include memory storing instructions. The electronic device may include at least one processor executing the instructions. When the at least one processor individually and/or collectively executes the instructions, the instructions may cause the electronic device to detect a change of a country that provides a mobile network based on a broadcast message received via the mobile network. When the at least one processor individually and/or collectively executes the instructions, the instructions may cause the electronic device to change a roaming SIM and a local SIM based on the change of country. When the at least one processor individually and/or collectively executes the instructions, the instructions may cause the electronic device to connect to the mobile network via the local SIM. When the at least one processor individually and/or collectively executes the instructions, the instructions may cause the electronic device to prevent and/or reduce degradation of communication performance between the local SIM and the mobile network by restricting repeated resource requests of the roaming SIM for an RF resource to register the roaming SIM with the mobile network.

According to an embodiment, when the at least one processor individually and/or collectively executes the instructions, the instructions may cause the electronic device to identify whether the roaming SIM is successfully registered. When the at least one processor individually and/or collectively executes the instructions, the instructions may cause the electronic device to, when the registration of the roaming SIM is rejected, determine whether a count of consecutive registration rejections of the roaming SIM exceeds a threshold value. When the at least one processor individually and/or collectively executes the instructions, the instructions may cause the electronic device to prevent and/or reduce the degradation of the communication performance due to a registration attempt of the roaming SIM, wherein the count of consecutive registration rejections of the roaming SIM exceeds the threshold value.

According to an embodiment, when the at least one processor individually and/or collectively executes the instructions, the instructions may cause the electronic device to prevent and/or reduce providing the RF resource to the roaming SIM when an RF priority related to the registration of the roaming SIM is less than an RF priority related to a data service of the local SIM.

According to an embodiment, when the at least one processor individually and/or collectively executes the instructions, the instructions may cause the electronic device to decrease an RF priority indicating a priority of using the RF resource of the roaming SIM.

According to an embodiment, when the at least one processor individually and/or collectively executes the instructions, the instructions may cause the electronic device to differently determine a decrement of the RF priority based on a rejection cause of the registration of the roaming SIM. When the at least one processor individually and/or collectively executes the instructions, the instructions may cause the electronic device to decrease the RF priority based on the determined decrement.

According to an embodiment, when the at least one processor individually and/or collectively executes the instructions, the instructions may cause the electronic device to determine a first decrement corresponding to a case in which the rejection cause is comprised in a first rejection cause to be greater than a second decrement corresponding to a case in which the rejection cause is comprised in a second rejection cause.

According to an embodiment, when the at least one processor individually and/or collectively executes the instructions, the instructions may cause the electronic device to increase a waiting time for retrying the registration of the roaming SIM.

According to an embodiment, when the at least one processor individually and/or collectively executes the instructions, the instructions may cause the electronic device to differently determine an increment of the waiting time based on a rejection cause of the registration of the roaming SIM. When the at least one processor individually and/or collectively executes the instructions, the instructions may cause the electronic device to increase the waiting time based on the determined increment.

According to an embodiment, when the at least one processor individually and/or collectively executes the instructions, the instructions may cause the electronic device to determine a first increment corresponding to a case in which the rejection cause is comprised in a first rejection cause to be greater than a second increment corresponding to a case in which the rejection cause is comprised in a second rejection cause.

According to an embodiment, when the at least one processor individually and/or collectively executes the instructions, the instructions may cause the electronic device to display a UI (e.g., the UI 810 of FIG. 8) to connect the electronic device to the mobile network via the local SIM, when the change of the country is detected.

According to an embodiment, an electronic device may include memory storing instructions. The electronic device may include at least one processor executing the instructions. When the at least one processor individually and/or collectively executes the instructions, the instructions may cause the electronic device to attempt to register a roaming SIM, in response to changing a local SIM connected to a mobile network. When the at least one processor individually and/or collectively executes the instructions, the instructions may cause the electronic device to identify whether the roaming SIM is successfully registered. When the at least one processor individually and/or collectively executes the instructions, the instructions may cause the electronic device to determine whether a count of consecutive registration rejections of the roaming SIM exceeds a threshold value, when the registration of the roaming SIM is rejected. When the at least one processor individually and/or collectively executes the instructions, the instructions may cause the electronic device to control an RF priority indicating a priority of using an RF resource of the roaming SIM and/or a waiting time for retrying the registration of the roaming SIM, when the count of consecutive registration rejections of the roaming SIM exceeds the threshold value.

According to an embodiment, a method of operating an electronic device may include detecting a change of country that provides a mobile network based on a broadcast message received via the mobile network. The method may include determining a roaming SIM and a local SIM based on the change of country. The method may include connecting to the mobile network via the local SIM. The method may include preventing degradation of communication performance between the local SIM and the mobile network by restricting repeated resource requests of the roaming SIM for an RF resource to register the roaming SIM with the mobile network.

According to an embodiment, the preventing of the degradation of the communication performance may include identifying whether the roaming SIM is successfully registered. The preventing of the degradation of the communication performance may include, when the registration of the roaming SIM is rejected, determining whether a count of consecutive registration rejections of the roaming SIM exceeds a threshold value. The preventing of the degradation of the communication performance may include preventing the degradation of the communication performance due to a registration attempt of the roaming SIM, when the count of consecutive registration rejections of the roaming SIM exceeds the threshold value.

According to an embodiment, the preventing of the degradation of the communication performance due to the registration attempt of the roaming SIM may include preventing provision of the RF resource to the roaming SIM when an RF priority related to the registration of the roaming SIM is less than an RF priority related to a data service of the local SIM.

According to an embodiment, the preventing of the degradation of the communication performance due to the registration attempt of the roaming SIM may include decreasing an RF priority indicating a priority of using the RF resource of the roaming SIM.

According to an embodiment, the decreasing of the RF priority may include differently determining a decrement of the RF priority based on a rejection cause of the registration of the roaming SIM. The decreasing of the RF priority may include decreasing the RF priority based on the determined decrement.

According to an embodiment, the differently determining of the decrement of the RF priority based on the rejection cause of the registration of the roaming SIM may include determining a first decrement corresponding to a case in which the rejection cause is comprised in a first rejection cause to be greater than a second decrement corresponding to a case in which the rejection cause is comprised in a second rejection cause.

According to an embodiment, the preventing of the degradation of the communication performance due to the registration attempt of the roaming SIM may include increasing a waiting time for retrying the registration of the roaming SIM.

According to an embodiment, the increasing of the waiting time for retrying the registration of the roaming SIM may include differently determining an increment of the waiting time based on a rejection cause of the registration of the roaming SIM. The increasing of the waiting time for retrying the registration of the roaming SIM may include increasing the waiting time based on the determined increment. “Based on” as used herein covers based at least one.

Each embodiment herein may be used in combination with any other embodiment(s) described herein.

According to an embodiment, a non-transitory computer-readable storage medium may store one or more computer programs including instructions. The instructions, when executed individually and/or collectively by at least one processor, may cause an electronic device to detect a change of a country that provides a mobile network based on a broadcast message received via the mobile network. The instructions, when executed individually and/or collectively by at least one processor, may cause the electronic device to determine a roaming SIM and a local SIM based on the change of the country. The instructions, when executed individually and/or collectively by at least one processor, may cause the electronic device to connect to the mobile network via the local SIM. The instructions, when executed individually and/or collectively by at least one processor, may cause the electronic device to prevent degradation of communication performance between the local SIM and the mobile network by restricting repeated resource requests of the roaming SIM for an RF resource to register the roaming SIM with the mobile network.

The embodiments of the present disclosure disclosed in the specification and the drawings are merely presented to easily describe technical contents of various embodiments of the present disclosure and help the understanding of them and are not intended to limit the various embodiments. Therefore, all changes or modifications derived from the technical idea of the various embodiments of the present disclosure as well as the various embodiments disclosed herein should be construed to fall within the various embodiments.

What is claimed is:

1. An electronic device, comprising:
memory storing instructions; and
at least one processor, comprising processing circuitry, for executing the instructions,
wherein the instructions, when individually and/or collectively executed by at least one processor, cause the electronic device to:
detect a change of a country that provides a mobile network based on a broadcast message,
change a roaming subscriber identification module (SIM) and a local SIM based on the change of country,
connect to the mobile network via the local SIM, and
prevent and/or reduce degradation of communication performance between the local SIM and the mobile network at least by restricting repeated resource requests of the roaming SIM for a radio frequency (RF) resource to register the roaming SIM with the mobile network.

2. The electronic device of claim 1, wherein the instructions, when individually and/or collectively executed by the at least one processor, cause the electronic device to:
identify whether the roaming SIM is successfully registered,
based on the registration of the roaming SIM being rejected, determine whether a count of consecutive registration rejections of the roaming SIM exceeds a threshold value, and
prevent and/or reduce the degradation of the communication performance due to a registration attempt of the roaming SIM, based on the count of consecutive registration rejections of the roaming SIM exceeding the threshold value.

3. The electronic device of claim 1, wherein the instructions, when individually and/or collectively executed by the at least one processor, cause the electronic device to prevent providing the RF resource to the roaming SIM when an RF priority related to the registration of the roaming SIM is less than an RF priority related to a data service of the local SIM.

4. The electronic device of claim 1, wherein the instructions, when individually and/or collectively executed by the at least one processor, cause the electronic device to decrease an RF priority indicating a priority of using the RF resource of the roaming SIM.

5. The electronic device of claim 1, wherein the instructions, when individually and/or collectively executed by the at least one processor, cause the electronic device to:
differently determine a decrement of the RF priority based on a rejection cause of the registration of the roaming SIM, and
decrease the RF priority based on the determined decrement.

6. The electronic device of claim 5, wherein the instructions, when individually and/or collectively executed by the at least one processor, cause the electronic device to determine a first decrement corresponding to a case in which the rejection cause is comprised in a first rejection cause to be greater than a second decrement corresponding to a case in which the rejection cause is comprised in a second rejection cause.

7. The electronic device of claim 2, wherein the instructions, when individually and/or collectively executed by the at least one processor, cause the electronic device to increase a waiting time for retrying the registration of the roaming SIM.

8. The electronic device of claim 7, wherein the instructions, when individually and/or collectively executed by the at least one processor, cause the electronic device to:
differently determine an increment of the waiting time based on a rejection cause of the registration of the roaming SIM, and
increase the waiting time based on the determined increment.

9. The electronic device of claim 5, wherein the instructions, when individually and/or collectively executed by the at least one processor, cause the electronic device to determine a first increment corresponding to a case in which the rejection cause is comprised in a first rejection cause to be greater than a second increment corresponding to a case in which the rejection cause is comprised in a second rejection cause.

10. The electronic device of claim 1, wherein the instructions, when individually and/or collectively executed by the at least one processor, cause the electronic device to display a user interface (UI) to connect the electronic device to the mobile network via the local SIM when the change of the country is detected.

11. An electronic device comprising:
memory storing instructions; and
at least one processor, comprising processing circuitry, for executing the instructions,
wherein the instructions, when individually and/or collectively executed by the at least one processor, cause the electronic device to:
attempt to register a roaming subscriber identification module (SIM), in response to changing a local SIM connected to a mobile network,
identify whether the roaming SIM is successfully registered,
when the registration of the roaming SIM is rejected, determine whether a count of consecutive registration rejections of the roaming SIM exceeds a threshold value, and
based on the count of consecutive registration rejections of the roaming SIM exceeding the threshold value, control a radio frequency (RF) priority indicating a priority of using an RF resource of the roaming SIM and/or a waiting time for retrying the registration of the roaming SIM.

12. A method of operating an electronic device, the method comprising:
detecting a change of country that provides a mobile network based on a broadcast message;
determining a roaming subscriber identification module (SIM) and a local SIM based on the change of country;
connecting to the mobile network via the local SIM; and
preventing and/or reducing degradation of communication performance between the local SIM and the mobile network at least by restricting repeated resource requests of the roaming SIM for a radio frequency (RF) resource to register the roaming SIM with the mobile network.

13. The method of claim 12, wherein the preventing and/or reducing of the degradation of the communication performance comprises:
identifying whether the roaming SIM is successfully registered;
when the registration of the roaming SIM is rejected, determining whether a count of consecutive registration rejections of the roaming SIM exceeds a threshold value; and
preventing and/or reducing the degradation of the communication performance due to a registration attempt of the roaming SIM when the count of consecutive registration rejections of the roaming SIM exceeds the threshold value.

14. The method of claim 12, wherein the preventing and/or reducing of the degradation of the communication performance due to the registration attempt of the roaming SIM comprises preventing provision of the RF resource to the roaming SIM when an RF priority related to the registration of the roaming SIM is less than an RF priority related to a data service of the local SIM.

15. The method of claim 12, wherein the preventing and/or reducing of the degradation of the communication performance due to the registration attempt of the roaming SIM comprises decreasing an RF priority indicating a priority of using the RF resource of the roaming SIM.

16. The method of claim 12, wherein the decreasing of the RF priority comprises:
differently determining a decrement of the RF priority based on a rejection cause of the registration of the roaming SIM; and
decreasing the RF priority based on the determined decrement.

17. The method of claim 12, wherein the differently determining of the decrement of the RF priority based on the rejection cause of the registration of the roaming SIM comprises determining a first decrement corresponding to a case in which the rejection cause is comprised in a first rejection cause to be greater than a second decrement corresponding to a case in which the rejection cause is comprised in a second rejection cause.

18. The method of claim 12, wherein the preventing and/or reducing of the degradation of the communication performance due to the registration attempt of the roaming SIM comprises increasing a waiting time for retrying the registration of the roaming SIM.

19. The method of claim 12, wherein the increasing of the waiting time for retrying the registration of the roaming SIM comprises:
differently determining an increment of the waiting time based on a rejection cause of the registration of the roaming SIM; and
increasing the waiting time based on the determined increment.

20. A non-transitory computer-readable storage medium storing instructions that, when executed by a processor, cause the processor to perform the method of o claim 12.
